(19) United States
(12) Patent Application Publication
(10) Pub. No.: US 2026/0279969 A1
(43) Pub. Date: Sep. 17, 2026

(54) COMPRESSIBLE BATTERY PAD

(71) Applicant: ROGERS CORPORATION, Chandler, AZ (US)

(72) Inventor: Anastassios Mavrokefalos, Lynnfield, MA (US)

(21) Appl. No.: 19/567,550

(22) Filed: Mar. 16, 2026

Related U.S. Application Data
(60) Provisional application No. 63/773,143, filed on Mar. 17, 2025.

(51) Int. Cl. H01M 10/658; H01M 10/613; H01M 10/653; H01M 50/291; H01M 50/293

(52) U.S. Cl. CPC H01M 10/658; H01M 10/613; H01M 10/653; H01M 50/291; H01M 50/293

(57) ABSTRACT

A compressible battery pad including a first polymer sheet; a second polymer sheet spaced apart from the first polymer sheet in a first direction; and polymer structures contacting the first polymer sheet and the second polymer sheet, extending in the first direction between the first polymer sheet and the second polymer sheet, and spaced apart from one another in a second direction orthogonal to the first direction, wherein the polymer structures are configured to non-linearly deform when a compressive force is applied to the first polymer sheet toward the second polymer sheet, the second polymer sheet toward the first polymer sheet, or a combination thereof.

### CROSS REFERENCE TO RELATED APPLICATION

The present application claims the benefit of priority to U.S. Provisional Application Ser. No. 63/773,143, filed Mar. 17, 2025, the entire contents of which are hereby incorporated by reference herein.

### BACKGROUND

This application is directed to a compressible battery pad, particularly for delaying or preventing thermal runaway in lithium-ion batteries. The application is further directed to methods for the manufacture of the compressible battery pad and battery components and batteries including the compressible battery pad(s).

The demand for electrochemical energy storage devices, such as lithium-ion batteries, is ever increasing due to the growth of applications such as electric vehicles and grid energy storage systems, as well as other multi-cell battery applications, such as electric bikes, uninterrupted power battery systems, and replacements for lead acid batteries. Due to their increasing use, methods for heat management are desired. For large format applications, such as grid storage and electric vehicles, multiple electrochemical cells connected in series and parallel arrays are often used, which can lead to thermal runaway. Once a cell is in thermal runaway mode, the heat produced by the cell can induce a thermal runaway propagation reaction in adjacent cells, with the potential to cause a cascading effect that can ignite the entire battery.

While attempts to reduce thermal runaway in batteries have been considered, many have drawbacks. For example, modifying the electrolyte by adding flame retardant additives, or using inherently non-flammable electrolytes have been considered, but these approaches can negatively impact the electrochemical performance of the battery. Other approaches for heat management or to prevent cascading thermal runaway include incorporating an increased amount of insulation between cells or clusters of cells to reduce the amount of thermal heat transfer during a thermal event. However, these approaches can limit the upper bounds of the energy density that can be achieved.

With the increasing demand for batteries with improved heat management or reduced risk of thermal runaway, there is accordingly a need for methods and components that prevents or delays the spread of heat, energy, or both to surrounding cells.

### BRIEF SUMMARY

In an aspect, a compressible battery pad includes a first polymer sheet; a second polymer sheet spaced apart from the first polymer sheet in a first direction; and polymer structures contacting the first polymer sheet and the second polymer sheet, extending in the first direction between the first polymer sheet and the second polymer sheet, and spaced apart from one another in a second direction orthogonal to the first direction, wherein the polymer structures are configured to non-linearly deform when a compressive force is applied to the first polymer sheet toward the second polymer sheet, the second polymer sheet toward the first polymer sheet, or a combination thereof.

An assembly for a battery includes the above-described compressible battery pad disposed between electrochemical cells.

Batteries including the above-described assembly are also disclosed.

The above-described and other features are exemplified by the following figures, detailed description, examples, and claims.

### BRIEF DESCRIPTION OF THE DRAWINGS

The following is a brief description of the drawings, which are presented for the purpose of illustrating the exemplary embodiments disclosed herein and not for the purpose of limiting the same.

FIG. 1A illustrates an exemplary geometry of an embodiment in an uncompressed state;

FIG. 1B illustrates the exemplary geometries of FIG. 1A in a compressed state;

FIG. 2A illustrates an exemplary geometry of an embodiment in an uncompressed state;

FIG. 2B illustrates the exemplary geometries of FIG. 2A in a compressed state;

FIG. 3A illustrates an exemplary geometry of an embodiment in an uncompressed state;

FIG. 3B illustrates the exemplary geometries of FIG. 3A in a compressed state;

FIG. 4A illustrates an exemplary geometry of an embodiment in an uncompressed state;

FIG. 4B illustrates the exemplary geometries of FIG. 4A in a compressed state;

FIG. 5A illustrates an exemplary geometry of an embodiment in an uncompressed state;

FIG. 5B illustrates the exemplary geometries of FIG. 5A in a compressed state;

FIG. 6A illustrates an exemplary geometry of an embodiment in an uncompressed state;

FIG. 6B illustrates the exemplary geometries of FIG. 6A in a compressed state;

FIG. 7 is a schematic drawing of an aspect of a compressible battery pad located in between two cells;

FIG. 8 is a schematic drawing of an aspect of a compressible battery pad located in between two electrochemical cells;

FIG. 9 is a schematic drawing of an aspect of a compressible battery pad located in a cell array;

FIG. 10 is a schematic drawing of an aspect of an assembly for a battery including the compressible battery pad;

FIG. 11 is an exploded views of a schematic of an apparatus for modeling of a thermal runaway test;

FIG. 12A shows modeling of a thermal runaway test including a battery pad having an uncompressed thickness of 10 millimeters (mm);

FIG. 12B shows modeling of a thermal runaway test including a battery pad having an uncompressed thickness of 10 mm;

FIG. 13A shows modeling of a thermal runaway test including a battery pad having an uncompressed thickness of 5 mm;

FIG. 13B shows modeling of a thermal runaway test including a battery pad having an uncompressed thickness of 5 mm;

FIG. 14A shows modeling of a thermal runaway test including a battery pad having an uncompressed thickness of 10 mm, compressed to 5 mm, with the polymer structures of the battery pad non-linearly deforming; and

FIG. 14B shows modeling of a thermal runaway test including a battery pad having an uncompressed thickness of 10 mm, compressed to 5 mm, with the polymer structures of the battery pad non-linearly deforming.

### DETAILED DESCRIPTION

Thermal management in batteries, for example, preventing thermal runaway in batteries, especially batteries that include a large plurality of electrochemical cells, is a difficult problem, as a cell adjacent to a cell experiencing a thermal runaway can absorb enough energy from the event to cause it to rise above its designed operating temperatures, triggering the adjacent cells to also enter into thermal runaway. This propagation of an initiated thermal runaway event can result in a chain reaction in which cells enter into a cascading series of thermal runaways, as the cells ignite adjacent cells. It has been particularly difficult to achieve effective thermal management properties in very thin pads, for example, pads that have a total thickness of 1 to 30 mm, or 1 to 20 mm, or 1 to 15 mm, or 1 to 10 mm, or 1 to 8 mm, or 1.5 to 8 mm, or 1.5 to 6 mm, or 4 to 6 mm. Thin pads are increasingly desired to reduce article size and weight, and to conserve material.

The compressible battery pad can be very thin and have good thermal insulation properties. The compressible battery pad can be subjected to multiple heating and cooling cycles, and still provide good thermal insulation. The compressible battery pad can further provide pressure management to the electrochemical cells and batteries. The compressible battery pad can be used in various sites in batteries to prevent thermal runaway. The compressible battery pad can further improve the flame resistance of batteries.

The present inventor has found that a polymer compressible battery pad including voids and connecting structures (also referred to herein as “polymer structures”) that deform in a way that the length of the polymer structures remains approximately constant can provide improved thermal resistance of the battery pad with compression, e.g., the compressed battery pad can provide improved thermal insulation. During compression, the polymer structures non-linearly deform, preserving the length of the polymer structures, and thermal resistance, e.g., thermal insulation, of the compressible battery pad with compression is improved. As used herein, the phrase “non-linearly deform” refers to deformation that does not include only compression such that the length of the polymer structure remains approximately constant, examples of which include bowing, buckling, rotation, twisting, or a combination thereof.

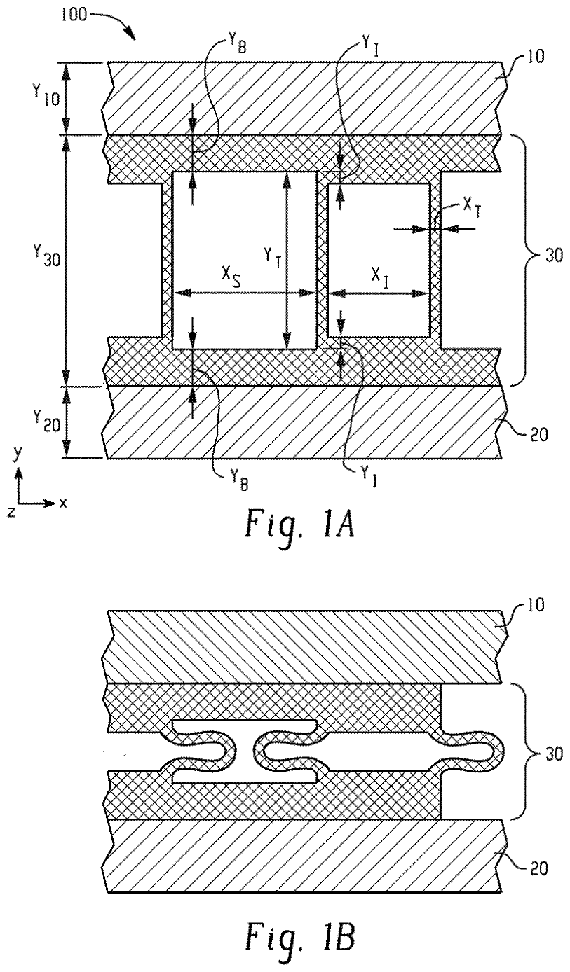

Accordingly, as shown in FIG. 1A, provided is a compressible battery pad 100 including a first polymer sheet 10; a second polymer sheet 20 spaced apart from the first polymer sheet 10 in a first direction (y-axis); and polymer structures 30 contacting the first polymer sheet 10 and the second polymer sheet 20, extending in the first direction (y-axis) between the first polymer sheet 10 and the second polymer sheet 20, and spaced apart from one another in a second direction (x-axis) orthogonal to the first direction (y-axis), wherein the polymer structures 30 are configured to non-linearly deform when a compressive force is applied to the first polymer sheet 10 toward the second polymer sheet 20, the second polymer sheet 20 toward the first polymer sheet 10, or a combination thereof. Although shown as flat, one or both or all of the outer surfaces, for example, the outer surfaces of the first polymer sheet 10, the second polymer sheet 20, or a combination thereof, can be contoured to provide better fit with a surface of an electrochemical cell.

With further reference to FIG. 1A, dimensions of the polymer structures 30 measured in a direction along the y-axis include an overall height Y₃₀, a height of base portions Y_{B}, a height of tines Y_{T}, and a height of an interior base portion Y₁ between tines, and dimensions of the polymer structures 30 measured in a direction along the x-axis include a width of the tines X_{T}, a width of the interior portion X_{I} between a pair of tines, and a spacing X_{S} between tine pairs. Exemplary values are provided in Table 1.

TABLE 1

| | Example 1 | Example 2 | | Example 3 | | Example 4 | |
|---|---|---|---|---|---|---|---|
| Y₃₀ | 3.5 mm | 3.5 | mm | 4.72 | mm | 1 to 15 | mm |
| Y_{B} | 0.4 mm | 0.4 | mm | 0.4 | mm | 0.1 to 1.5 | mm |
| Y_{T} | 2.7 mm | 2.7 | mm | 4 | mm | 1 to 15 | mm |
| Y_{I} | 0.2 mm | 0.36 | mm | 0.36 | mm | 0.1 to 1.5 | mm |
| X_{T} | 0.5 mm | 0.5 | mm | 0.5 | mm | 0.1 to 1.5 | mm |
| X_{I} | 0.2 mm | 0.5 | mm | 0.5 | mm | 0.1 to 1.5 | mm |
| X_{S} | 2.3 mm | 2.3 | mm | 2.3 | mm | 1 to 10 | mm |

A total void, e.g., air, volume of the polymer structures 30 can be, for example, 45 to 90%, 50 to 85%, 55 to 80%, or 60 to 75%, and with reference to the examples in Table 1, 71% for Example 1, 65% for Example 2, and 71% for Example 3.

Dimensions of the first polymer sheet 10 and the second polymer sheet 20 measured in a direction along the y-axis (i.e., Y₁₀ and Y₂₀, respectively) can independently be, for example, 0.01 to 3 mm, depending on the whether the first polymer sheet, the second polymer sheet, or a combination thereof includes a nonporous structure, a foam, or a combination thereof. For example, the first polymer sheet, the second polymer sheet, or a combination thereof including a nonporous structure or film can have a thickness of 0.01 mm and the first polymer sheet, the second polymer sheet, or a combination thereof including a foam can have a thickness of 3 mm.

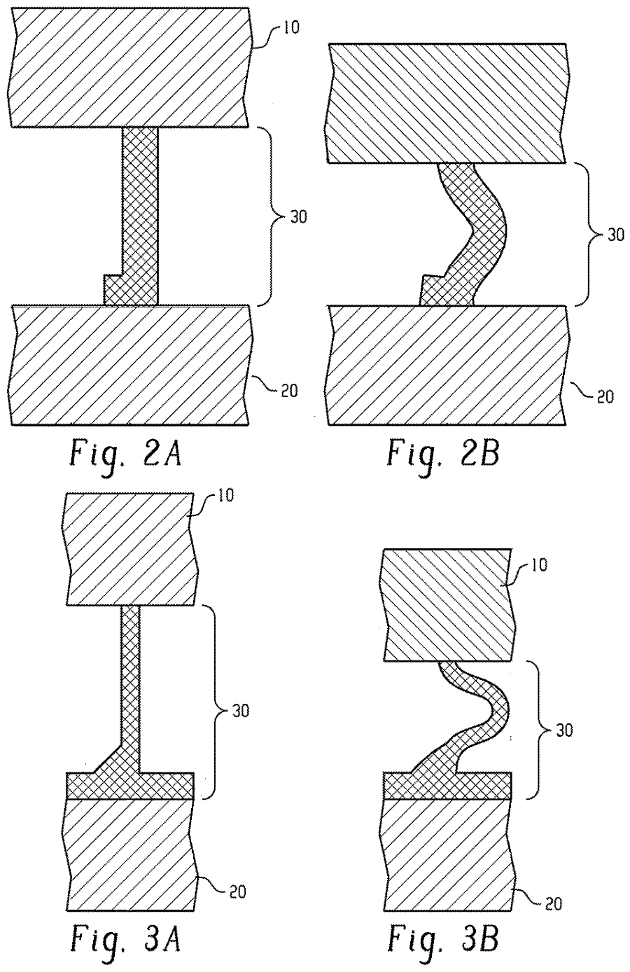

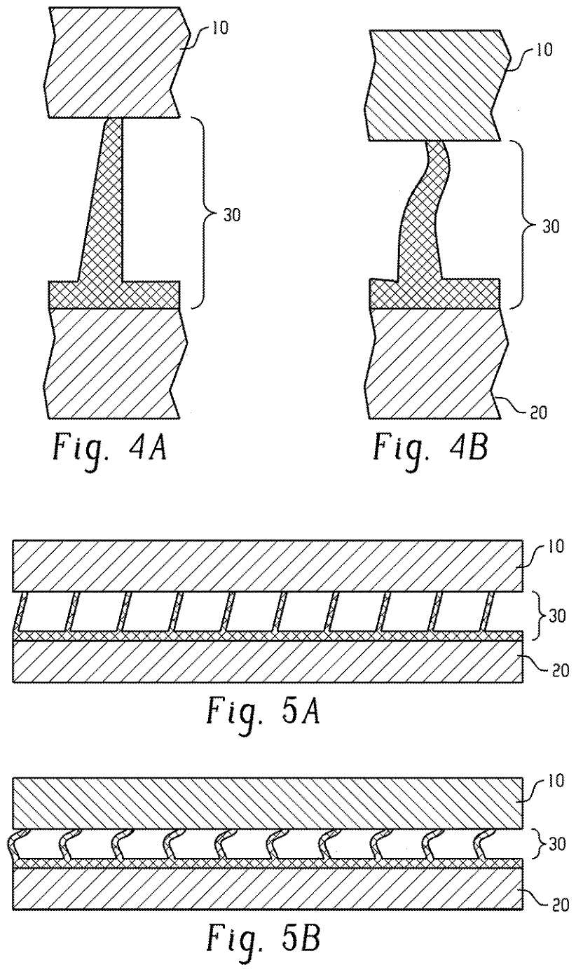

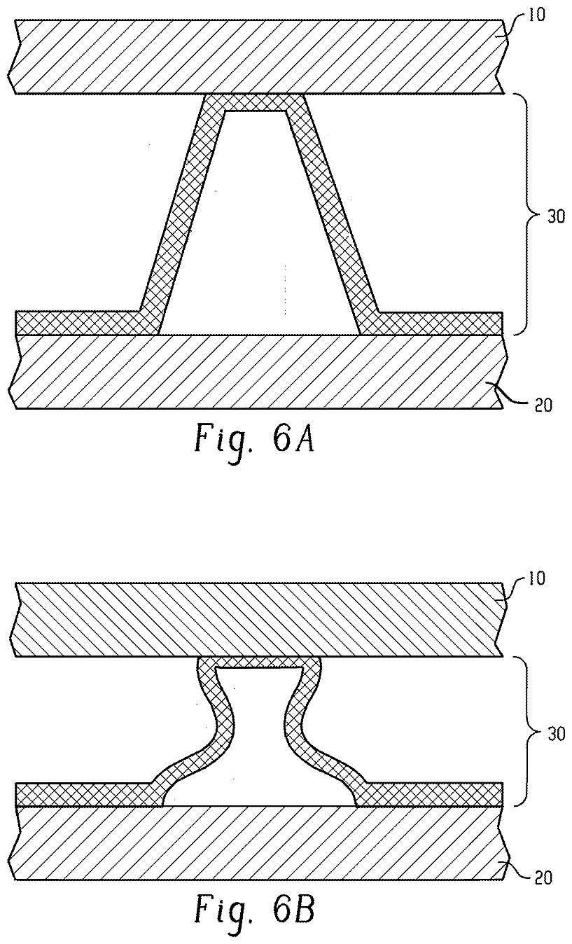

FIG. 1A, FIG. 2A, FIG. 3A, FIG. 4A, FIG. 5A, and FIG. 6A illustrate exemplary geometries of an embodiment in an uncompressed state. FIG. 1B, FIG. 2B, FIG. 3B, FIG. 4B, FIG. 5B, and FIG. 6B illustrate the exemplary geometries of FIG. 1A, FIG. 2A, FIG. 3A, FIG. 4A, FIG. 5A, and FIG. 6A, respectively, in a compressed state. In FIGS. 1B, FIG. 2B, FIG. 3B, FIG. 4B, FIG. 5B, and FIG. 6B, a compressive force is applied to the first polymer sheet 10 toward the second polymer sheet 20.

The polymer structures may not be symmetric in the second direction. See, for example, FIG. 1A, FIG. 2A, FIG. 3A, FIG. 4A, and FIG. 5A. The polymer structures may not be symmetric in the first direction. See, for example, FIG. 2A, FIG. 3A, FIG. 4A, FIG. 5A, and FIG. 6A. Each of the polymer structures can include a first dimension measured in the second direction at the first polymer sheet, and a second dimension measured in the second direction at the second polymer sheet, and the first dimension may not be equal to the second dimension. See, for example, FIG. 2A, FIG. 3A, FIG. 4A, and FIG. 6A.

### Nonporous Structure

Each of the first polymer sheet, second polymer sheet, and polymer structures can independently include a nonporous structure. The nonporous structure can include an elastomer having a permeability coefficient for water of less than 20 g-mm per m² per day, or less than 10 g-mm per m² per day, or less than 5 g-mm per m² per day, each measured at 25° C. and 1 atmosphere; or a tensile stress at 100% elongation of 0.5 to 15 megaPascals measured at 21° C. in accordance with ASTM 412; or a combination thereof.

The nonporous structure can include an elastomeric material that is hydrophobic, to prevent water or water vapor transmission. For example, the nonporous structure can include a thermoplastic elastomer (TPE), provided that it has a desirable hydrophobicity (lack of water or water vapor transmission). Classes of TPEs include styrenic block copolymers (TPS or TPE-s), (TPO or TPE-o), thermoplastic vulcanizates (TPV or TPE-v), thermoplastic polyurethane, thermoplastic copolyesters (TPC or TPE-E), thermoplastic polyamides (TPA or TPE-A), and others.

Examples of elastomeric materials that can be used include an acrylic rubber, butyl rubber, halogenated butyl rubber, copolyester, epichlorohydrin rubber, ethylene-acrylic rubber, ethylene-butyl acrylic rubber, ethylene-diene rubber (EPR) such as ethylene-propylene rubber, ethylene-propylene-diene monomer rubber (EPDM), ethylene-vinyl acetate, fluoroelastomer, perfluoroelastomer, polyamide, polybutadiene, polychloroprene, polyolefin rubber, polyisoprene, polysulfide rubber, natural rubber, nitrile rubber, low density polyethylene, polypropylene, thermoplastic polyurethane elastomer (TPU), silicone rubber, fluorinated silicone rubber, styrene-butadiene, styrene-isoprene, vinyl rubber, or a combination thereof.

The nonporous structure can include a thermoplastic or a thermoset. As used herein, the term “thermoplastic” refers to a material that is plastic or deformable, melts to a liquid when heated, and freezes to a brittle, glassy state when cooled sufficiently. Examples of thermoplastic polymers that can be used include cyclic olefin polymers (including polynorbornenes and copolymers containing norbornenyl units, for example, copolymers of a cyclic polymer such as norbornene and an acyclic olefin such as ethylene or propylene), fluoropolymers (for example, polyvinyl fluoride (PVF), polyvinylidene fluoride (PVDF), fluorinated ethylene-propylene (FEP), polytetrafluoroethylene (PTFE), poly(ethylene-tetrafluoroethylene (PETFE), or perfluoroalkoxy (PFA)), polyacetals (for example, polyoxyethylene or polyoxymethylene), poly(C₁₋₆ alkyl)acrylates, polyacrylamides (including unsubstituted and mono-N- or di-N—(C₁₋₈ alkyl)acrylamides), polyacrylonitriles, polyamides (for example, aliphatic polyamides, polyphthalamides, or polyaramides), polyamideimides, polyanhydrides, polyarylene ethers (for example, polyphenylene ethers), polyarylene ether ketones (for example, polyether ether ketones (PEEK) or polyether ketone ketones (PEKK)), polyarylene ketones, polyarylene sulfides (for example, polyphenylene sulfides (PPS)), polyarylene sulfones (for example, polyethersulfones (PES) or polyphenylene sulfones (PPS)), polybenzothiazoles, polybenzoxazoles, polybenzimidazoles, polycarbonates (including homopolycarbonates or polycarbonate copolymers such as polycarbonate-siloxanes, polycarbonate-esters, or polycarbonate-ester-siloxanes), polyesters (for example, polyethylene terephthalates, polybutylene terephthalates, polyarylates, or polyester copolymers such as polyester-ethers), polyetherimides (for example, copolymers such as polyetherimide-siloxane copolymers), polyimides (for example, copolymers such as polyimide-siloxane copolymers), poly(C₁₋₆ alkyl) methacrylates, polyalkylacrylamides (for example, unsubstituted and mono-N- or di-N—(C₁₋₈ alkyl)acrylamides), polyolefins (for example, polyethylenes, such as high density polyethylene (HDPE), low density polyethylene (LDPE), or linear low density polyethylene (LLDPE), polypropylenes, or their halogenated derivatives (such as polytetrafluoroethylenes), or their copolymers, for example, ethylene-alpha-olefin copolymers), polyoxadiazoles, polyoxymethylenes, polyphthalides, polysilazanes, polysiloxanes (silicones), polystyrenes (for example, copolymers such as acrylonitrile-butadiene-styrene (ABS) or methyl methacrylate-butadiene-styrene (MBS)), polysulfides, polysulfonamides, polysulfonates, polysulfones, polythioesters, polytriazines, polyureas, polyurethanes, vinyl polymers (for example, polyvinyl alcohols, polyvinyl esters, polyvinyl ethers, polyvinyl halides (for example, polyvinyl chloride), polyvinyl ketones, polyvinyl nitriles, or polyvinyl thioethers), a paraffin wax, or the like. A combination including at least one of the foregoing thermoplastic polymers can be used.

Thermoset polymers are derived from thermosetting monomers or prepolymers (resins) that can irreversibly harden and become insoluble with polymerization or cure, which can be induced by heat or exposure to radiation (e.g., ultraviolet light, visible light, infrared light, or electron beam (e-beam) radiation). Thermoset polymers include alkyds, bismaleimide polymers, bismaleimide triazine polymers, cyanate ester polymers, benzocyclobutene polymers, benzoxazine polymers, diallyl phthalate polymers, epoxies, hydroxymethylfuran polymers, melamine-formaldehyde polymers, phenolics (including phenol-formaldehyde polymers such as novolacs and resoles), benzoxazines, polydienes such as polybutadienes (including homopolymers or copolymers thereof, e.g., poly(butadiene-isoprene)), polyisocyanates, polyureas, polyurethanes, triallyl cyanurate polymers, triallyl isocyanurate polymers, certain silicones, and polymerizable prepolymers (e.g., prepolymers having ethylenic unsaturation, such as unsaturated polyesters, polyimides), or the like. The prepolymers can be polymerized, copolymerized, or crosslinked, e.g., with a reactive monomer such as styrene, alpha-methylstyrene, vinyltoluene, chlorostyrene, acrylic acid, (meth)acrylic acid, a (C₁₋₆ alkyl)acrylate, a (C₁₋₆ alkyl) methacrylate, acrylonitrile, vinyl acetate, allyl acetate, triallyl cyanurate, triallyl isocyanurate, or acrylamide.

The thermoset can include a thermoset epoxy resin. The thermoset epoxy resin can be derived from a thermosetting composition, for example, including an epoxy monomer. The thermosetting composition can be ionically cured or thermally cured.

The epoxy monomer can include one or more epoxy monomers. The epoxy monomers can include non-halogenated epoxy compounds. The epoxy monomers can include at least one of a glycidyl ether of an alcohol compound (for example, of at least one of butanediol, polyethylene glycol, or polypropylene glycol); a glycidyl ether of a phenol compound (for example, of at least one of bisphenol A, bisphenol F, bisphenol S, phenol novolac, cresol novolac, or resorcinol novolac); a glycidyl ether of a phenolic resin (for example, at least one of para-xylene-modified phenolic resin, meta-xylene para-xylene-modified phenolic resin, terpene modified phenolic resin, dicyclopentadiene modified phenolic resin, cyclopentadiene modified phenolic resin, polycyclic aromatic-ring-modified phenolic resin, or naphthalene-ring-containing phenolic resin); a glycidyl ester of a carboxylic acid compound (for example, of at least one of phthalic acid, isophthalic acid, or tetrahydrophthalic acid); a glycidyl or methylglycidyl epoxy monomer (for example, aniline or isocyanuric acid where an active hydrogens bonded to a nitrogen atom are substituted with glycidyl groups); an alicyclic epoxy monomer (for example, at least one of vinyl cyclohexene epoxide, 3,4-epoxycyclohexylmethyl-3,4-epoxycyclohexane carboxylate, or 2-(3,4-epoxy)cyclohexyl-5,5-spiro(3,4-epoxy)cyclohexane-m-dioxane); an epoxidized product of bis(4-hydroxy)thioether; a stilbene type epoxy monomer; or a halogenated phenol novolac type epoxy monomer. The epoxy monomer can include at least one of an epoxidized phenol novolac or an epoxidized cresol novolac.

The thermoset epoxy resin can include residues of an epoxy functional phenol-formaldehyde novolac. The epoxy functional phenol-formaldehyde novolac can be modified with a butadiene-acrylonitrile toughener, for example, with a carboxyl-terminated butadiene acrylonitrile (CTBN). The thermoset epoxy resin can include residues of a 9,10-dihydro-9-oxa-10-phosphaphenanthrene-10-oxide (DOPO) functional bisphenol A Phenol-Formaldehyde novolac. The thermosetting composition can include one or more of these multi-part epoxy systems.

### Foam

Each of the first polymer sheet, second polymer sheet, and polymer structures can include a foam. The foam can include open cells. The foam can include closed cells. The foam can include open cells and closed cells.

The foam includes a plurality of openings, i.e., pores. The pores are defined by an inner surface of the foam material. The pores can be interconnected or discrete. A combination of interconnected and discrete pores can be present. The pores can be wholly contained within the foam, or at least a portion of the pores can be open to a surface of the foam, allowing communication with the surrounding environment. At least a portion of the pores can be interconnected and at least a portion of the pores are open, allowing passage of air, water, water vapor, or the like from first outer surface to the opposite second outer surface, referred to herein as an “open-celled foam”. The foam can be a “closed cell foam”, where the pores may or may not interconnect, and are substantially not open to a surface of the foam, or are completely closed, such that the foam does not allow substantial passage of air, water, water vapor, or the like from one outer surface to the other outer surface. The foam can be a substantially closed-cell foam, or a completely closed-cell foam.

Each of the polymer structures can be bonded to the first polymer sheet, the second polymer sheet, or a combination thereof. Each of the polymer structures can be bonded to the first polymer sheet, the second polymer sheet, or a combination thereof, for example, by adhesive, fusing by heat, or during a curing process, e.g., when drop casting layers.

The compressible battery pad can include a monolith. As used herein, the term “unitary,” “monolith,” or “monolithic,” for example, a unitary component or a monolith or monolithic structure, refers to a three-dimensional construction, e.g., one body, that can be formed from portions that can have substantially identical or identical compositions. A monolith can be made of a single, continuous material, e.g., polymer material, and can be manufactured using various techniques, including injection molding, compression molding, and extrusion. Accordingly, a unitary component differs from a laminate or assembly of differing constituents, which includes an interface between differing constituents thereof. A unitary component can be integrally formed, for example, integrally molded in a single mold. Similarly, as used herein, portions can be “integrally formed,” or one portion can be “integrally formed” with a different portion, resulting in a unitary component differing from a laminate or assembly of differing constituents, which includes an interface between differing constituents thereof.

The thermally resistive battery pad is selected to be inert to the ordinary operating conditions of a battery such as a lithium-ion battery. Various materials for the thermally resistive battery pad can be used.

For example, each of the first polymer sheet, second polymer sheet, and polymer structures can include silicone. Each of the first polymer sheet, second polymer sheet, and polymer structures can include polyurethane.

### Polyurethane Foam

Each of the first polymer sheet, second polymer sheet, and polymer structures can include a cured polyurethane foam. A method of forming a thermally resistive battery pad for a battery including a cured polyurethane foam includes combining an active hydrogen-containing component (also referred to herein as “Part A”) including a polyol and an isocyanate component (also referred to herein as “Part B”) including a polyisocyanate to form an uncured polyurethane foam; and curing the uncured polyurethane foam to form the cured polyurethane foam. The thermally resistive battery pad can consist essentially of, or consists of the cured polyurethane foam.

The thermally resistive battery pad can be manufactured from polyurethane foam-forming compositions. The polyurethane foams can be formed from a reactive composition including an organic isocyanate-containing component reactive with an active hydrogen-containing composition, a surfactant, and a catalyst. Each of the organic isocyanate component and the active hydrogen-containing component can include one or more different types of each type of compound.

The organic polyisocyanate component used in the preparation of polyurethane foams includes at least a polyisocyanate having the general formula Q(NCO)ᵢ, wherein i is an integer having an average value of two or greater, and Q is an organic radical having a valence of i. Q can be a substituted or unsubstituted group (for example, an alkane or an aromatic group of the appropriate valency). Q can be a group having the formula Q¹-Z-Q¹ wherein Q¹ is an alkylene or arylene group and Z is —O—, —O-Q¹-S—, —CO—, —S—, —S-Q¹-S—, —SO—, or —SO₂—. Q can represent a polyurethane radical having a valence of i.

Examples of suitable polyisocyanates include hexamethylene diisocyanate, 1,8-diisocyanato-p-methane, xylyl diisocyanate, diisocyanatocyclohexane, phenylene diisocyanates, tolylene diisocyanates, including 2,4-tolylene diisocyanate, 2,6-tolylene diisocyanate, and crude tolylene diisocyanate, bis(4-isocyanatophenyl)methane, chlorophenylene diisocyanates, diphenylmethane-4,4′-diisocyanate (also known as 4,4′-diphenyl methane diisocyanate, or MDI) and adducts thereof, naphthalene-1,5-diisocyanate, triphenylmethane-4,4′,4″-triisocyanate, isopropylbenzene-alpha-4-diisocyanate, or polymeric isocyanates such as polymethylene polyphenylisocyanate.

The active hydrogen-containing component includes at least one multi-functional active hydrogen containing compound, which can be a polyamine or a polyol, for example a polyether polyol, a polyester polyol, a lower molecular weight polyol, or a combination thereof. Suitable polyester polyols are inclusive of polycondensation products of polyols with dicarboxylic acids or ester-forming derivatives thereof (such as anhydrides, esters and halides), polylactone polyols obtainable by ring-opening polymerization of lactones in the presence of polyols, polycarbonate polyols obtainable by reaction of carbonate diesters with polyols, or castor oil polyols. Suitable dicarboxylic acids and derivatives of dicarboxylic acids that are useful for producing polycondensation polyester polyols are aliphatic or cycloaliphatic dicarboxylic acids such as glutaric, adipic, sebacic, fumaric or maleic acids; dimeric acids; aromatic dicarboxylic acids such as phthalic, isophthalic or terephthalic acids; tribasic or higher functional polycarboxylic acids such as pyromellitic acid; as well as anhydrides or second alkyl esters, such as maleic anhydride, phthalic anhydride or dimethyl terephthalate. The polymers of cyclic esters can also be used. The preparation of cyclic ester polymers from at least one cyclic ester monomer is exemplified by U.S. Pat. Nos. 3,021,309 through 3,021,317; 3,169,945; and 2,962,524. Suitable cyclic ester monomers include but are not limited to δ-valerolactone; ∈-caprolactone; zeta-enantholactone; the monoalkyl-valerolactones, e.g., the monomethyl-, monoethyl-, and monohexyl-valerolactones. In general the polyester polyol may include a caprolactone-based polyester polyol, an aromatic polyester polyol, an ethylene glycol adipate-based polyol, or a combination thereof. Polyester polyols made from ∈-caprolactones, adipic acid, phthalic anhydride, and terephthalic acid or dimethyl esters of terephthalic acid are generally preferred.

Polyether polyols can be obtained by the chemical addition of alkylene oxides, such as ethylene oxide, propylene oxide, or a combination thereof, to water or polyhydric organic components, such as ethylene glycol, propylene glycol, trimethylene glycol, 1,2-butylene glycol, 1,3-butanediol, 1,4-butanediol, 1,5-pentanediol, 1,2-hexylene glycol, 1,10-decanediol, 1,2-cyclohexanediol, 2-butene-1,4-diol, 3-cyclohexene-1,1-dimethanol, 4-methyl-3-cyclohexene-1,1-dimethanol, 3-methylene-1,5-pentanediol, diethylene glycol, (2-hydroxyethoxy)-1-propanol, 4-(2-hydroxyethoxy)-1-butanol, 5-(2-hydroxypropoxy)-1-pentanol, 1-(2-hydroxymethoxy)-2-hexanol, 1-(2-hydroxypropoxy)-2-octanol, 3-allyloxy-1,5-pentanediol, 2-allyloxymethyl-2-methyl-1,3-propanediol, [4,4-pentyloxy)-methyl]-1,3-propanediol, 3-(o-propenylphenoxy)-1,2-propanediol, 2,2′-diisopropylidenebis(p-phenyleneoxy) diethanol, glycerol, 1,2,6-hexanetriol, 1,1,1-trimethylolethane, 1,1,1-trimethylolpropane, 3-(2-hydroxyethoxy)-1,2-propanediol, 3-(2-hydroxypropoxy)-1,2-propanediol, 2,4-dimethyl-2-(2-hydroxyethoxy)-methylpentanediol-1,5; 1,1,1-tris[2-hydroxyethoxy)methyl]-ethane, 1,1,1-tris[2-hydroxypropoxy)-methyl]propane, diethylene glycol, dipropylene glycol, pentaerythritol, sorbitol, sucrose, lactose, alpha-methylglucoside, alpha-hydroxyalkylglucoside, a novolac polymer, phosphoric acid, benzenephosphoric acid, a polyphosphoric acid such as tripolyphosphoric acid and tetrapolyphosphoric acid, ternary condensation products, and the like. The alkylene oxides used in producing polyoxyalkylene polyols can have 2 to 4 carbon atoms, or 2 to 3 carbon atoms. Exemplary alkylene oxides are propylene oxide and mixtures of propylene oxide with ethylene oxide. Polytetramethylene polyether diol or glycol, and mixture with one or more other polyols, can be specifically mentioned. The polyols listed above can be used per se as the active hydrogen component.

A specific class of polyether polyols is represented generally by the formula R[(OCₙH₂ₙ)_{z}OH]ₐ wherein R is hydrogen or a polyvalent hydrocarbon radical; a is an integer (i.e., 2 to 8) equal to the valence of R, n in each occurrence is an integer from 2 to 4 inclusive (preferably 3) and z in each occurrence is an integer having a value of 2 to 200, preferably 15 to 100. Specifically, the polyether polyol can have the formula R[(OC₄H₈)_{z}OH]₂, wherein R is a divalent hydrocarbon radical and z in each occurrence is 2 to about 40, specifically 5 to 25.

Another type of active hydrogen-containing material that can be used is a polymer polyol composition obtained by polymerizing ethylenically unsaturated monomers with a polyol as described in U.S. Pat. No. 3,383,351, the disclosure of which is incorporated herein by reference. Suitable monomers for producing such compositions include acrylonitrile, vinyl chloride, styrene, butadiene, vinylidene chloride, and other ethylenically unsaturated monomers as identified and described in the above-mentioned U.S. Patent. Suitable polyols include those listed and described above and in U.S. Pat. No. 3,383,351. The active hydrogen-containing component may also contain polyhydroxy-containing compounds such as hydroxyl-terminated polyhydrocarbons (U.S. Pat. No. 2,877,212); hydroxyl-terminated polyformals (U.S. Pat. No. 2,870,097); fatty acid triglycerides (U.S. Pat. Nos. 2,833,730 and 2,878,601); hydroxyl-terminated polyesters (U.S. Pat. Nos. 2,698,838, 2,921,915, 2,591,884, 2,866,762, 2,850,476, 2,602,783, 2,729,618, 2,779,689, 2,811,493, 2,621,166 and 3,169,945); hydroxymethyl-terminated perfluoromethylenes (U.S. Pat. Nos. 2,911,390 and 2,902,473); hydroxyl-terminated polyalkylene ether glycols (U.S. Pat. No. 2,808,391; British Patent No. 733,624); hydroxyl-terminated polyalkylenearylene ether glycols (U.S. Pat. No. 2,808,391); and hydroxyl-terminated polyalkylene ether triols (U.S. Pat. No. 2,866,774).

The active-hydrogen-containing component, in particular the polyol component, can further include a very low molecular weight chain extender, cross-linking agent, or combination thereof. Exemplary chain extenders and cross-linking agents include alkane diols, dialkylene glycols and/or polyhydric alcohols, preferably triols and tetrols, having a molecular weight from about 200 to 400 Dalton. The chain extenders and cross-linking agents can be used, for example in an amount of 0.5 to 20 percent by weight, or 10 to 15 percent by weight, based on the total weight of the active-hydrogen-containing component. Other chain extenders can be a very low molecular weight (below about 200 Dalton) diol, including but not being limited to, dipropylene glycol, 1,4-butanediol, 2-methyl-1,3-propanediol, and 3-methyl-1,5-pentane diol.

The active hydrogen-containing component can be a polyol component that includes a higher molecular weight polyether polyol, for example a polyether polyol having a weight average molecular weight (Mw) of 500 to about 4,000, or 1,000 and 3,000, and a hydroxy number of 10 to 200; a polyester polyol, such as a polycaprolactone-based polyol, or a combination thereof, and a very low molecular weight polyol as a chain extender or crosslinking agent. Exemplary polyether polyols include polyoxyalkylene diols and triols, and polyoxyalkylene diols and triols with polystyrene and/or polyacrylonitrile grafted onto the polymer chain, or a combination thereof. A triol can be present, such as a polycaprolactone triol having an Mw of 50 to 3,000 and a hydroxy number can be 200 to 2,000, preferably 500 to 1500. A preferred triol is a polycaprolactone triol.

In general, the average weight percent hydroxy, based on the hydroxyl numbers of the hydroxyl-containing compounds (including all polyols or diols), including other cross-linking additives, surfactants, catalysts, and pigments, if used, can be 500 to 400, depending on the desired firmness or softness of the polyurethane. The hydroxyl number is defined as the number of milligrams of potassium hydroxide required for the complete neutralization of the hydrolysis product of the fully acetylated derivative prepared from 1 gram of polyol or polyol component with or without other cross-linking additives.

A number of catalysts can be used to catalyze the reaction of the isocyanate component with the active hydrogen-containing component. The amount of catalyst in the uncured polyurethane foam is 0.001 to 9 wt %, or 0.04 to 9 wt %, or 0.04 to 7 wt %, or 3 to 7 wt %, of catalyst, based on a total weight of the uncured polyurethane foam. Such catalysts include organic and inorganic acid salts of, or organometallic derivatives of bismuth, lead, tin, iron, antimony, uranium, cadmium, cobalt, thorium, aluminum, mercury, zinc, nickel, cerium, molybdenum, vanadium, copper, manganese, or zirconium, as well as phosphines or tertiary organic amines of these metals. Examples of such catalysts are dibutyltin dilaurate, dibutyltin diacetate, stannous octoate, lead octoate, cobalt naphthenate, bis(2,4-pentanedionate) nickel (II) or derivatives thereof such as diacetonitrilediacetylacetonato nickel, diphenylnitrilediacetylacetonato nickel, or bis(triphenylphosphine)diacetyl acetylacetonato nickel. The catalyst can include ferric acetylacetonate, triethylamine, triethylenediamine, N,N,N′,N′-tetramethylethylenediamine, 1,1,3,3-tetramethylguanidine, N,N,N′N′-tetramethyl-1,3-butanediamine, N,N-dimethylethanolamine, N,N-diethylethanolamine, 1,3,5-tris(N,N-dimethylaminopropyl)-s-hexahydrotriazine, o- and p-(dimethylaminomethyl) phenols, 2,4,6-tris(dimethylaminomethyl) phenol, N,N-dimethylcyclohexylamine, pentamethyldiethylenetriamine, 1,4-diazobicyclo [2.2.2] octane, N-hydroxyl-alkyl quaternary ammonium carboxylates and tetramethylammonium formate, tetramethylammonium acetate, or tetramethylammonium 2-ethylhexanoate. A catalyst delay agent can optionally be present, for example as is described in U.S. Pat. Nos. 10,023,681, 9,228,047 and 5,733,945. A combination of at least two different catalysts can be used.

The reactive composition can include a surfactant that can stabilize the reactive composition before it is cured. The surfactant can include an organosilicone surfactant. The organosilicone can include a copolymer including or consisting essentially of SiO₂ (silicate) units and (CH₃)₃SiO_{0.5} (trimethylsiloxy) units in a molar ratio of silicate to trimethylsiloxy units of 0.8:1 to 2.2:1, or 1:1 to 2.0:1. The organosilicone can include a partially cross-linked siloxane-polyoxyalkylene block copolymer, wherein the siloxane blocks and polyoxyalkylene blocks are linked by silicon to carbon, or by silicon to oxygen to carbon. The surfactant can be present in an amount of 0.5 to 10 wt %, or 1 to 6 wt %, based on the total weight of the active hydrogen component. The surfactant is present in an amount of 0.1 to 7 wt %, or 2 to 5 wt %, based on a total weight of the uncured polyurethane foam.

Other, optional additives can be added to the reactive composition. For example, the additive can include a desiccant, dyes, pigments (for example, titanium dioxide or iron oxide), antioxidants, antiozonants, UV stabilizers, or a combination thereof.

Methods for the manufacture of foams are generally known. The foams can be mechanically frothed, physically or chemically blown, or both. The polyurethane foams can be made by casting a mechanically frothed composition. In particular, the reactive precursors of the polyurethane can be mixed and mechanically, frothed, then cast to form a layer, and cured.

Physical blowing agents can be used alone or as mixtures with each other or with one or more chemical blowing agents. Physical blowing agents can be selected from a broad range of materials, including hydrocarbons, ethers, esters and partially halogenated hydrocarbons, ethers, and esters, and the like. Typical physical blowing agents have a boiling point of −50 to 100° C., or −50 to 50° C. Exemplary physical blowing agents include CFC's (chlorofluorocarbons) (for example, 1,1-dichloro-1-fluoroethane, 1,1-dichloro-2,2,2-trifluoro-ethane, monochlorodifluoromethane, or 1-chloro-1,1-difluoroethane); FC's (fluorocarbons) (for example, 1,1,1,3,3,3-hexafluoropropane, 2,2,4,4-tetrafluorobutane, 1,1,1,3,3,3-hexafluoro-2-methylpropane, 1,1,1,3,3-pentafluoropropane, 1,1,1,2,2-pentafluoropropane, 1,1,1,2,3-pentafluoropropane, 1,1,2,3,3-pentafluoropropane, 1,1,2,2,3-pentafluoropropane, 1,1,1,3,3,4-hexafluorobutane, 1,1,1,3,3-pentafluorobutane, 1,1,1,4,4,4-hexafluorobutane, 1,1,1,4,4-pentafluorobutane, 1,1,2,2,3,3-hexafluoropropane, 1,1,1,2,3,3-hexafluoropropane, 1,1-difluoroethane, 1,1,1,2-tetrafluoroethane, or pentafluoroethane); FE's (fluoroethers) (for example, methyl-1,1,1-trifluoroethylether or difluoromethyl-1,1,1-trifluoroethylether); or hydrocarbons (for example, n-pentane, isopentane, or cyclopentane). The physical blowing agent can include at least one of carbon dioxide, ethane, propane, n-butane, isobutane, pentane, hexane, butadiene, acetone, methylene chloride, any of the chlorofluorocarbons, hydrochlorofluorocarbons, or hydrofluorocarbons. As with the chemical blowing agents, the physical blowing agents can be used in an amount sufficient to give the resultant foam the desired bulk density. Typically, physical blowing agents are used in an amount of 5 to 50 wt %, or 10 to 30 wt %, based on the total weight of the reactive composition.

If a chemical blowing agent is used, it can include at least one of water, an azo compound (for example, azoisobutyronitrile, azodicarbonamide (i.e. azo-bis-formamide), or barium azodicarboxylate); a substituted hydrazine (for example, diphenylsulfone-3,3′-disulfohydrazide, 4,4′-hydroxy-bis-(benzenesulfohydrazide), trihydrazinotriazine, or aryl-bis-(sulfohydrazide)); a semicarbazide (for example, p-tolylene sulfonyl semicarbazide, or 4,4′-hydroxy-bis-(benzenesulfonyl semicarbazide)); a triazole (for example, 5-morpholyl-1,2,3,4-thiatriazole); an N-nitroso compound (for example, N,N′-dinitrosopentamethylene tetramine or N,N-dimethyl-N,N′-dinitrosophthalmide); benzoxazine (for example, isatoic anhydride); or a mixture (for example, a sodium carbonate/citric acid mixture). The chemical blowing agent can include water. The blowing agent can include at least one of an ammonium salt, a phosphate, a polyphosphate, a borate, a polyborate, a sulphate, a urea, a urea-formaldehyde resin, a dicyandiamide, or a melamine.

The amount of the foregoing chemical blowing agents will vary depending on the agent and the desired foam density, and is readily determinable by one of ordinary skill in the art. In general, these chemical blowing agents are used in an amount of 0.1 to 10 wt %, based on the total weight of the reactive composition. The decomposition products formed during the decomposition process can be physiologically safe, and that may not significantly adversely affect the thermal stability or mechanical properties of the foamed polyurethane.

The polyurethane foam can be produced by mechanically mixing the reactive composition (including the isocyanate component, the active hydrogen-containing component, a froth-stabilizing surfactant, the catalyst, and other optional additives) with a froth-forming gas. The frothed mixture can be fed onto a release liner and spread to a layer of desired thickness by a doctoring blade or other suitable spreading device. The gauged layer of the frothed mixture can then be delivered to one or more heating zones. After the heating zone, the formed polyurethane layer can be passed to a cooling zone.

For example, in the production of polyurethane foams, the reactive components of the polyurethane foam-forming composition can be formulated in two parts, one part (“Part A”) containing the active hydrogen-containing component, the surfactant, and if used the inhibitor, and a chemical blowing agent; and the other part (“Part B”) containing the organic isocyanate component. The parts can be metered, mixed, and cast, for example, into a mold or a continuous coating line. The foaming and curing then occurs either in the mold or on the continuous coating line. In a method of production, the reactive components of the polyurethane foam-forming composition can be introduced into an extruder together with a chemical blowing agent, a physical blowing agent, or other additives if used. The catalyst can then be metered into the extruder to start the foaming and curing reaction. The use of physical blowing agents such as liquid carbon dioxide or supercritical carbon dioxide in conjunction with chemical blowing agents such as water can give rise to foam having much lower densities.

In an aspect, 70 to 90 wt %, or 75 to 89 wt %, of the active hydrogen-containing component (“Part A”) and 10 to 30 wt %, or 11 to 25 wt %, of the isocyanate component (“Part B”) can be combined to form the uncured polyurethane foam.

Optionally, the thermally resistive battery pad can be immersed in water for a period of time, for example, 24 hours, to imbibe water into the thermally resistive battery pad. The high heat capacity of liquid water can contribute to significantly delaying heat transfer from one surface of the thermally resistive battery pad to the other surface of the thermally resistive battery pad.

The compressible battery pad can maintain its elastic behavior over many cycles on compression deflection over the life of the battery, properties reflected by compressive force deflection and compression set of the foam. The compressible battery pad can have a compression force deflection of 0.2 to 450 psi (1 to 3,100 kPa), or 0.2 to 10 psi (1 to 69 kPa), or 0.2 to 20 psi (1 to 138 kPa), each at 25% deflection and determined in accordance with ASTM D3574-17. The compressible battery pad can have a compression set of 0 to 15%, or 0 to 10%, or 0 to 5%, or greater than 0 to 15%, or greater than 0 to 10%, or greater than 0 to 5%, determined in accordance with ASTM D 3574-95 Test D at 70° C.

Foams with good compression set resistance provide cushioning, and maintain their original shape or thickness under loads for extended periods. The foam, e.g., the cured polyurethane foam, can have a compression force deflection of 0.2 to 125 pounds per square inch (psi) (1 to 862 kilopascals (kPa)), or 0.25 to 20 psi (1.7 to 138 kPa), or 0.5 to 10 psi (3.4 to 68.90.5 kPa), each at 25% deflection and determined in accordance with ASTM D3574-17. The compressible battery pad, e.g., the cured polyurethane foam, can have a compression set of 0 to 15%, or 0 to 10%, or 0 to 5%, or greater than 0 to 15%, or greater than 0 to 10%, or greater than 0 to 5%, determined in accordance with ASTM D 3574-95 Test D at 70° C.

### Silicone Foam

The silicone foam can include a poly(dialkyl siloxane), for example a poly(dimethyl siloxane). The silicone foam can be prepared from a curable composition including an alkenyl-containing component. The alkenyl-containing component can include an alkenyl-diterminated polyorganosiloxane. The alkenyl-diterminated polyorganosiloxane can be represented by the formula:

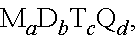

wherein the subscripts a, b, c, and d are zero or a positive integer, subject to the limitation that if subscripts a and b are both equal to zero, subscript c is greater than or equal to two; M has the formula R₃SiO_{1/2}; D has the formula R₂SiO_{2/2}; T has the formula RSiO_{3/2}; and Q has the formula SiO_{4/2}, wherein each R group independently represents hydrogen, terminally-substituted C₁₋₆ alkenyl groups, substituted and unsubstituted monovalent hydrocarbon groups having from 1 to 40, or 1 to 6 carbon atoms each, subject to the limitation that at least 1, for example, at least 2, of the R groups are alkenyl R groups. Suitable alkenyl R-groups are exemplified by vinyl, allyl, 1-butenyl, 1-pentenyl, and 1-hexenyl, with vinyl being particularly useful. The alkenyl group is bonded at the molecular chain terminals, i.e., an alkenyl-terminated polyorganosiloxane. As used herein, an alkenyl-diterminated polyorganosiloxane refers to a polyorganosiloxane wherein two of the chain ends are alkenyl groups. The alkenyl-diterminated polyorganosiloxane can be a vinyl-diterminated polyorganosiloxane. As used herein, a vinyl group is a group having the formula —CH═CH₂, and a “substituted vinyl group” has the formula —CH═CR₂, where the R groups can be independently hydrogen or C₁₋₆ alkyl groups. The vinyl concentration in the alkenyl-terminated polyorganosiloxane can be, for example 0.001 to 3 wt %, or 0.01 to 0.5 wt %, or 0.01 to 0.15 wt %, or 0.01 to 0.1 wt %.

Other silicon-bonded organic groups in the alkenyl-terminated polyorganosiloxane, when present, are exemplified by substituted and unsubstituted monovalent hydrocarbon groups having from one to forty carbon atoms, for example, alkyl groups such as methyl, ethyl, propyl, butyl, pentyl, and hexyl; aryl groups such as phenyl, tolyl, and xylyl; aralkyl groups such as benzyl and phenethyl; and halogenated alkyl groups such as 3-chloropropyl and 3,3,3-trifluoropropyl. Methyl and phenyl are specifically useful.

The alkenyl-diterminated polyorganosiloxane can have straight chain, partially branched straight chain, branched-chain, or a network molecular structure, or can be a mixture of such structures. The alkenyl-diterminated polyorganosiloxane is exemplified by vinyl-endblocked polydimethylsiloxanes; vinyl-endblocked dimethylsiloxane-diphenylsiloxane copolymers; vinyl-endblocked dimethylsiloxane-methylphenylsiloxane copolymers; vinyl-endblocked dimethylsiloxane-methylphenylsiloxane-diphenylsiloxane copolymers; vinyl-endblocked dimethylsiloxane-methylphenylsiloxane copolymers; vinyl dimethylsiloxane-methylvinylsiloxane copolymers; vinyl-endblocked methylvinylsiloxane-methylphenylsiloxane copolymers; vinyl-endblocked dimethylsiloxane-methylvinylsiloxane-methylphenylsiloxane copolymers; dimethylvinylsiloxy-endblocked methylvinylpolysiloxanes; dimethylvinylsiloxy-endblocked methylvinylphenylsiloxanes; dimethylvinylsiloxy-endblocked dimethylvinylsiloxane-methylvinylsiloxane copolymers; dimethylvinylsiloxy-endblocked dimethylsiloxane-methylphenylsiloxane copolymers; dimethylvinylsiloxy-endblocked dimethylsiloxane-diphenylsiloxane copolymers; or a combination thereof. The alkenyl-diterminated polyorganosiloxane can include a vinyl-diterminated polydimethylsiloxane.

The alkenyl-diterminated polyorganosiloxane can have a viscosity of 100 to 150,000 centipoise (cP). The alkenyl-diterminated polyorganosiloxane can have a viscosity of greater than 10,000 cP, for example, 10,000 to 150,000 cP, or 50,000 to 150,000 cP. The alkenyl-diterminated polyorganosiloxane can include a vinyl-diterminated polydimethysiloxane having a viscosity of greater than 10,000 cP, for example, 10,000 to 150,000 cP, or 50,000 to 150,000 cP.

The alkenyl-diterminated polyorganosiloxane can include more than one alkenyl-diterminated polyorganosiloxane, for example at least two alkenyl-diterminated polyorganosiloxanes. The alkenyl-diterminated polyorganosiloxane can include a first alkenyl-diterminated polyorganosiloxane having a viscosity of greater than 10,000 cP, for example, 10,000 to 150,000 cP, or 50,000 to 150,000 cP, and a second alkenyl-diterminated polyorganosiloxane having a viscosity of greater than 10,000 cP, for example, greater than 10,000 to 150,000 cP, or 50,000 to 150,000 cP. The first alkenyl-diterminated polyorganosiloxane can be a first vinyl-diterminated polydimethysiloxane, for example, a first vinyl-diterminated polydimethylsiloxane. The second alkenyl-diterminated polyorganosiloxane can be a second vinyl-diterminated polydimethysiloxane, for example, a second vinyl-diterminated polydimethylsiloxane.

The alkenyl-diterminated polyorganosiloxane can be present in the curable composition for forming the silicone foam (hereinafter “curable composition”) in an amount of 30 to 99.9 wt %, based on the total weight of the curable composition. Within this range, the alkenyl-diterminated polyorganosiloxane can be present in the curable composition in an amount of 30 to 90 wt %, or 30 to 70 wt %, or 35 to 68 wt %, or 35 to 65 wt %, or 38 to 65 wt %, or 40 to 45 wt %, each based on the total weight of the curable composition.

In addition to the alkenyl-containing component, the curable composition comprises a hydride-containing component. The hydride-containing component can include a hydride-substituted polyorganosiloxane.

The hydride-substituted polyorganosiloxane can have at least two silicon-bonded hydrogen atoms per molecule, and is generally represented by the formula:

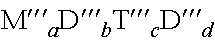

wherein the subscripts a, b, c, and d are zero or a positive integer, subject to the limitation that if subscripts a and b are both equal to zero, subscript c is greater than or equal to two; M′″ has the formula R₃SiO_{1/2}; D′″ has the formula R₂SiO_{2/2}; T′″ has the formula RSiO_{3/2}; and Q′″ has the formula SiO_{4/2}, wherein each R group independently represents hydrogen, substituted and unsubstituted monovalent hydrocarbon groups having from one to forty, or one to six carbon atoms each, subject to the limitation that at least two of the R groups are hydrogen. For example, each of the R groups of the polyorganosiloxane having at least two silicon-bonded hydrogen atoms per molecule are independently selected from hydrogen, methyl, ethyl, propyl, butyl, pentyl, hexyl, aryl, phenyl, tolyl, xylyl, aralkyl, benzyl, phenethyl, halogenated alkyl, 3-chloropropyl, 3,3,3-trifluoropropyl, or a combination thereof. Methyl and phenyl can be preferred.

The hydrogen can be bonded to silicon at the molecular chain terminals, in pendant positions on the molecular chain, or both. The hydrogens can be substituted at terminal positions. At least 3 to 4 hydrogens can be present per molecule. The hydrogen-containing polyorganosiloxane component can have straight chain, partially branched straight chain, branched-chain, cyclic, or network molecular structure, or can be a mixture of two or more different polyorganosiloxanes with the exemplified molecular structures.

The hydride-containing polyorganosiloxane can include, for example, trimethylsiloxy-endblocked methylhydrogenpolysiloxanes; trimethylsiloxy-endblocked dimethylsiloxane-methylhydrogensiloxane copolymers; trimethylsiloxy-endblocked methylhydrogensiloxane-methylphenylsiloxane copolymers; trimethylsiloxy-endblocked dimethylsiloxane-methylhydrogensiloxane-methylphenylsiloxane copolymers; dimethylhydrogensiloxy-endblocked dimethylpolysiloxanes; dimethylhydrogensiloxy-endblocked methylhydrogenpolysiloxanes; dimethylhydrogensiloxy-endblocked dimethylsiloxanes-methylhydrogensiloxane copolymers; dimethylhydrogensiloxy-endblocked dimethylsiloxane-methylphenylsiloxane copolymers; and dimethylhydrogensiloxy-endblocked methylphenylpolysiloxanes. The hydride-substituted polyorganosiloxane can include a trimethylsiloxy-endblocked methylhydrogenpolysiloxane.

The silicone hydride-containing component can include silicon-bonded hydrogen atoms and an alkenyl group. The alkenyl group can be a vinyl group, and can be positioned at a chain end of the silicon-hydride containing component.

The silicone hydride-containing component can have a hydride content ranging from 0.01 to 10 percent by weight and a viscosity ranging from 10 to 10,000 centipoise at 25° C. The hydride-substituted polyorganosiloxane can include a trimethylsiloxy-endblocked methylhydrogenpolysiloxane having a hydride content of 0.1 to 5 wt %, or 0.5 to 2 wt %, or 1 to 2 wt %. The hydride-substituted polyorganosiloxane can include a trimethylsiloxy-endblocked methylhydrogenpolysiloxane having a viscosity of 10 to 50 cP, or 10 to 30 cP, or 15 to 30 cP, or 20 to 30 cP. The hydride-substituted polyorganosiloxane can include a trimethylsiloxy-endblocked methylhydrogenpolysiloxane having a hydride content of 0.1 to 5 wt %, or 0.5 to 2 wt %, or 1 to 2 wt % and a viscosity of 10 to 50 cP, or 10 to 30 cP, or 15 to 30 cP, or 20 to 30 cP.

Combinations of hydride-containing polyorganosiloxanes are also contemplated by the present disclosure.

The hydride-substituted polyorganosiloxane component is used in an amount sufficient to cure the composition. For example, the alkenyl-containing component and the hydride-containing component can be present in a weight ratio of alkenyl-containing component:hydride-containing component of 8:1 to 40:1, or 10:1 to 40:1, or 13:1 to 40:1, or 8:1 to 25:1, or 13:1 to 25:1, or 8:1 to 20:1, or 13:1 to 20:1. The hydride-substituted polyorganosiloxane component can be used in a quantity that provides a molar ratio of hydride groups to a sum of vinyl and hydroxyl groups of 1.1 to 2.5, or 1.1 to 1.5.

The hydride-substituted polyorganosiloxane component can be provided with a carrier fluid. The carrier fluid can be a polyorganosiloxane, for example having the structure

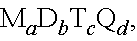

wherein M, D, T, Q and the subscripts a, b, c, and d are as previously defined. The carrier fluid can include a second alkenyl-terminated polyorganosiloxane, which can be the same or different from the alkenyl-terminated polyorganosiloxane described previously. For example, the second alkenyl-terminated polyorganosiloxane can be different from the alkenyl-terminated polyorganosiloxane described previously in chemical composition, viscosity, or both. The second alkenyl-terminated polyorganosiloxane can be different from the alkenyl-terminated polyorganosiloxane described previously in viscosity. The second alkenyl-terminated polyorganosiloxane can be an alkenyl-diterminated polyorganosiloxane, wherein two of the chain ends are alkenyl groups. As used herein, a vinyl group is a group having the formula —CH═CH₂, and a “substituted vinyl group” has the formula —CH═CR₂, where the R groups can be independently hydrogen or C₁₋₆ alkyl groups. The vinyl concentration in the second alkenyl-terminated polyorganosiloxane can be, for example 0.001 to 1 wt %, or 0.01 to 0.5 wt %, or 0.01 to 0.15 wt %, or 0.01 to 0.1 wt %.

The carrier fluid can include a second alkenyl-terminated polyorganosiloxane having a viscosity of greater than 500 cP, for example greater than 1,000 cP, or greater than 5,000 cP. The second alkenyl-terminated polyorganosiloxane can have a viscosity of 500 to 10,000 cP.

When included in a carrier fluid, the hydride-substituted polyorganosiloxane component can be present in the carrier fluid in a weight ratio of 10:90 to 90:10, or 50:50 to 85:15, or 60:40 to 70:30.

In addition to the alkenyl-containing component and the hydride-containing component, the curable composition can further optionally include a cure catalyst, a blowing agent, an inhibitor, or a combination thereof.

The cure catalyst can be a hydrosilylation-reaction catalyst. Effective catalysts promote the addition of silicon-bonded hydrogen onto alkenyl multiple bonds to accelerate cure. Such catalyst can include a noble metal, such as, for example, platinum, rhodium, palladium, ruthenium, iridium, or a combination thereof. The catalyst can also include a support material, such as activated carbon, aluminum oxide, silicon dioxide, polymer resin, or a combination thereof.

The cure catalyst can be present in amounts of up to 1,000 parts per million by weight (ppmw) of metal (e.g., platinum). The cure catalyst can be present in an amount of 1 to 500 ppmw, or 1 to 250 ppmw, or 1 to 100 ppmw, or 1 to 50 ppmw, or 5 to 50 ppmw, or 10 to 50 ppmw.

Platinum and platinum-containing compounds can be preferred, and include, for example platinum black, platinum-on-alumina powder, platinum-on-silica powder, platinum-on-carbon powder, chloroplatinic acid, alcohol solutions of chloroplatinic acid platinum-olefin complexes, platinum-alkenylsiloxane complexes and the catalysts afforded by the microparticulation of the dispersion of the catalyst in a polymer resin such as methyl methacrylate, polycarbonate, polystyrene, silicone, and the like. A combination of different catalysts can also be used. When a platinum catalyzed system is used, poisoning of the catalyst can occur, which can cause formation of an uncured or poorly cured silicone composition that is low in strength. Additional platinum can be added, but when a large amount of platinum is added to improve cure, the pot life or working time can be adversely affected. Methyl vinyl (M^{vi}M^{vi}) components can be used as a cure retardant, for example DOWSIL™ 1-2287 Cure Inhibitor from Dow Corning. Such materials bind the platinum at room temperature to prevent cure and hence, improve the working time, but release the platinum at higher temperatures to affect cure in the required period of time. The level of platinum and cure retardant can be adjusted to alter cure time and working time/pot life. When a higher platinum level is used, it is typically less than or equal to 100 ppmw, based on a total weight of the curable polyorganosiloxane composition. Within this range, the additional platinum concentration (i.e., the amount over that required) can be greater than or equal to 50 ppmw, or greater than or equal to 60 ppmw, based on the total weight of the curable composition. Also within this range, the additional platinum concentration can be less than or equal to 90 ppmw, or less than or equal to 80 ppmw, based on a total weight of the curable composition.

The cure retardant concentration (if a cure retardant is used) is less than or equal to 0.3 wt % of the total curable polyorganosiloxane composition. Within this range, the cure retardant concentration is greater than or equal to 0.005 wt %, or greater than or equal to 0.025 wt % based on the total weight of the curable polyorganosiloxane composition. Also within this range, the cure retardant concentration is less than or equal to 0.2 wt %, or less than or equal to 0.1 wt %, based on the total weight of curable composition and the required working time or pot life.

The curable composition can further include a blowing agent. The blowing agent can include a chemical blowing agent. The blowing agent can include water, a silanol-terminated polyorganosiloxane, and a C₁₋₁₂ monoalcohol (which includes diols, triols, carbinols, and the like). The silanol-terminated polyorganosiloxane can have a viscosity of 20 to 40,000 cP, or 400 to 2,000 cP, or 500 to 1,000 cP. The silanol-terminated polyorganosiloxane can include hydroxyl-terminated polydimethylsiloxane. The alcohol can include a C₁₋₆ alcohol. The alcohol can include 1-butanol. The alcohol may consist of a monoalcohol.

Suitable blowing agents can also include physical blowing agents. These blowing agents can be chosen from a broad range of materials, including hydrocarbons, ethers, esters and partially halogenated hydrocarbons, ethers and esters, or the like. Examples of physical blowing agents have a boiling point from −50 to 100° C., or from −50 to 50° C. Exemplary hydrocarbon and substituted (e.g., halogenated hydrocarbons) can include, for example, HCFC's (halo chlorofluorocarbons) such as 1,1-dichloro-1-fluoroethane, 1,1-dichloro-2,2,2-trifluoro-ethane, monochlorodifluoromethane, and 1-chloro-1,1-difluoroethane; the HFCs (halo fluorocarbons) such as 1,1,1,3,3,3-hexafluoropropane, 2,2,4,4-tetrafluorobutane, 1,1,1,3,3,3-hexafluoro-2-methylpropane, 1,1,1,3,3-pentafluoropropane, 1,1,1,2,2-pentafluoropropane, 1,1,1,2,3-pentafluoropropane, 1,1,2,3,3-pentafluoropropane, 1,1,2,2,3-pentafluoropropane, 1,1,1,3,3,4-hexafluorobutane, 1,1,1,3,3-pentafluorobutane, 1,1,1,4,4,4-hexafluorobutane, 1,1,1,4,4-pentafluorobutane, 1,1,2,2,3,3-hexafluoropropane, 1,1,1,2,3,3-hexafluoropropane, 1,1-difluoroethane, 1,1,1,2-tetrafluoroethane, (Z)-1,1,1,4,4,4-hexafluoro-2-butene, and pentafluoroethane; the HFE's (halo fluoroethers) such as methyl-1,1,1-trifluoroethylether and difluoromethyl-1,1,1-trifluoroethylether; and the hydrocarbons such as n-pentane, isopentane, and cyclopentane. The blowing agent can include carbon dioxide, nitrogen, argon, water, air, nitrogen, and inert gases (such as helium and argon), as well as combinations thereof. The blowing agent can include carbon dioxide, for example solid carbon dioxide (i.e., dry ice), liquid carbon dioxide, gaseous carbon dioxide, or supercritical carbon dioxide.

The blowing agent can be present in the curable composition in a total amount of 0.16 to 2 wt %, or 0.5 to 2 wt %, based on the total weight of the curable composition. The blowing agent can include a chemical blowing agent, and the chemical blowing agent can be present in the curable composition in a total amount of 0.16 to 2 wt %, or 0.5 to 2 wt %, based on the total weight of the curable composition. Water can be included in an amount of 0.01 to 1 wt %, based on the total weight of the curable composition. The silanol-terminated polyorganosiloxane can be present in an amount of 0.1 to 1 wt %, based on the total weight of the curable composition. The C₁₋₁₂ monoalcohol can be present in an amount of 0.05 to 0.5 wt %, based on the total weight of the curable composition.

The curable composition can optionally further include an inhibitor. Inhibitors suitable for use in the curable composition can include alkenyl-diterminated polyorganosiloxanes which can be represented by the formula:

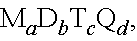

as discussed herein. The function as an inhibitor, the alkenyl-diterminated polyorganosiloxane inhibitor can have a vinyl content of greater than or equal to 15 wt % (based on the total weight of the alkenyl-diterminated polyorganosiloxane inhibitor), a molecular weight of less than 500 grams per mole (g/mol), or both. The inhibitor can be present and include an alkenyl-diterminated polyorganosiloxane having have a vinyl content of greater than or equal to 15 wt %, for example 15 to 40 wt %, or 20 to 40 wt %, or 25 to 35 wt %, and a molecular weight of less than 500 g/mol, for example 50 to 450 g/mol, or 100 to 400 g/mol, or 100 to 250 g/mol.

When present, the inhibitor can be included in the curable composition in an amount of 0.05 to 0.5 wt %, based on a total weight of the alkenyl-containing component and the hydride-containing component in the curable composition.

Other additives can be present in either part of the curable compositions (as discussed herein), for example, an ultraviolet (UV) stabilizer, antistatic agent, dye, pigment, antimicrobial or antiviral agent, and the like, or a combination thereof. When additives are present, the amounts used are selected so that the desired properties of the cured silicone composition are not adversely affected by the presence of the additives.

The curable composition for preparing the silicone foam can include the alkenyl-containing component and the hydride-containing component. The curable composition for preparing the silicone foam can further include a cure catalyst and a blowing agent. Each component can be as described herein and present in amounts described herein.

The curable silicone composition can be manufactured by combining the various components in any suitable order. The curable composition can be provided as a first part and a second part. The first part can include the alkenyl-containing component, and the second part can include the hydride-containing component. The first part can further include the cure catalyst, the blowing agent, the inhibitor, or a combination thereof. The first part and the second part can be mixed, metered, or cast, for example into a mold or on a continuous coating line, to provide the corresponding cured material. Curing and foaming can then occur either in the mold or on the continuous coating line.

The alkenyl-containing component and the hydride-containing component can be present in the curable composition in amounts effective to provide a weight ratio of alkenyl-containing component:hydride-containing component of 10:1 to 40:1, or 13:1 to 40:1, or 13:1 to 25:1, or 13:1 to 20:1. The curable composition can include a molar ratio of hydride groups to a sum of alkenyl and hydroxyl groups of 1.1:1 to 2.5:1, or 1.1:1 to 2:1, or 1.1:1 to 1.5:1.

Other components not specifically described herein can be minimized (i.e., present in an amount of less than or equal to 5 wt %, or less than or equal to 1 wt %, or less than or equal to 0.5 wt %, or less than or equal to 0.1 wt %, or less than or equal to 0.01 wt %, each based on the total weight of the curable composition) or excluded from the curable composition and the cured products (e.g., silicone foams) prepared form the curable compositions. For example, the curable composition can optionally minimize or exclude polymers other that the various polyorganosiloxanes described herein. The curable composition can optionally minimize or exclude surfactants such as fluorinated surfactants. The curable composition or the process of manufacturing the silicone foams described herein can optionally minimize or exclude physical blowing agents.

A cured silicone foam layer can be formed by casting the curable composition followed by curing the cast composition. Post-cure can be used to advance cure to near complete status, developing desirable physical properties. The cured silicone foams described herein are considered as free-standing silicone foams. Free-standing as used herein means that no supporting layers are present. Thus, any discussion of particular properties associated with the cured silicone foams according to the present disclosure will be understood to refer to the properties of the silicone foam layer itself, in the absence of any supporting layers.

Liquid material inputs of the curable composition can be mixed and cast onto a moving release layer. Another release layer can be pulled through on top of the cast mixture and the sandwiched mixture is then passed through the nip of two rotating rollers to meter the amount of the curable composition, which determines the thickness of the partially cured foam, and ultimately, the final foam. The gap thickness between the rolls (i.e., the nip gap) can be adjusted to decrease the thickness of the sandwiched mixture as it passes between them. The nip gap can be, for example, 0.005 to 0.5 inch (0.127 to 12.7 mm), or 0.01 to 0.1 inches (0.254 to 2.54 mm), or 0.01 to 0.05 inches (0.254 to 1.27 mm), or 0.02 to 0.04 inches (0.508 to 1.016 mm). During the metering step, the width of the sandwiched mixture can be maintained, but the length of the sandwiched mixture can increase as the thickness decreases. In another aspect, a second release layer on top of the cast mixture and rollers are not used, and a process such as knife-over-roll can be used to determine the thickness of the partially cured foam, and ultimately, the final foam.

The coated release layer passes through an oven, which can be heated by at least one platen, by heated air, other means, or a combination thereof to foam and at least partially cure the cast composition. Two or more curing ovens at the same or different temperatures can be used. Temperatures in the oven(s) can be 80 to 200° F. (43.3 to 60° C.) and residence time for the coated carrier in the oven(s) can be varied to achieve the desired level of cure. Upon exiting the oven, when an additional top layer of carrier film is used, the additional top layer can be removed.

The silicone foam can be rolled on a drum for storage and optional heating/post-curing, for example at a temperature of 100 to 300° F. (65.6 to 121.1° C.) for 6 to 48 hours. Post-cure is especially useful to lower compression set, eliminate volatile compounds, and complete cure if needed.

An adhesive layer can be present to adhere a compressible battery pad to another compressible battery pad, another type of layer, or to a component of a battery such as a cell. A wide variety of suitable adhesives can be used in the compressible battery pad. The adhesive can be selected for ease of application and stability under the operating conditions of the battery. Each adhesive layer can be the same or different, and be of the same or different thickness. Suitable adhesives include a phenolic resin, an epoxy adhesive, a polyester adhesive, a polyvinyl fluoride adhesive, an acrylic or methacrylic adhesive, or a silicone adhesive, for example, an acrylic adhesive or a silicone adhesive. The adhesive can be a silicone adhesive. Solvent-cast, hot-melt, and two-part adhesives can be used. Each of the adhesive layers can independently have a thickness of 0.00025 to 0.010 inches (0.006 to 0.25 mm), or 0.0005 to 0.003 inches (0.01 to 0.08 mm).

The silicone foams can advantageously maintain their elastic behavior over many cycles of compression deflection over the life of the silicone foam, properties reflected by compressive force deflection and compression set of the silicone foam. Foams with good compression set resistance provide cushioning and maintain their original shape or thickness under loads for extended periods. The silicone foam can have a compression force deflection (CFD) of less than 25 kilopascals (kPa), or 5 to less than 25 kPa, or 10 to 23 kPa, each at 25% deflection. The silicone foam can have a CFD of less than 120 kPa, or 10 to less than 120 kPa, or 10 to 100 kPa, or 20 to 100 kPa, each at 50% deflection. The silicone foam can have a CFD of less than 1,000 kPa, or 100 to less than 1,000 kPa, or 100 to 800 kPa, or 150 to 800 kPa, each at 80% deflection. Compression force deflection is determined in accordance with ASTM D1056-20. The silicone foam can have a compression set of 0 to 5%, determined in accordance with ASTM D1056-20 B2.

The compressible battery pad can be used as a single layer. Multiple single layers can be stacked, however, and used as a single layer. Other layers can be used in combination with the compressible battery pad, for example, a flame retardant layer, an adhesive layer, or the like, or a combination thereof. However, one advantage of the compressible battery pad is that a single pad used alone can be effective without other layers even at thicknesses as low as 1 to 30 mm, or 1 to 20 mm, or 1 to 15 mm, or 1 to 10 mm, or 1 to 8 mm, or 1 to 6 mm.

An adhesive layer can be present to adhere a compressible battery pad to another compressible battery pad, another type of layer, or to a component of the cell array or battery. A wide variety of suitable adhesives can be used in the compressible battery pad. The adhesive can be selected for ease of application and stability under the operating conditions of the battery. Each adhesive layer can be the same or different, and be of the same or different thickness. Suitable adhesives include a phenolic resin, an epoxy adhesive, a polyester adhesive, a polyvinyl fluoride adhesive, an acrylic or methacrylic adhesive, or a silicone adhesive, preferably an acrylic adhesive or a silicone adhesive. The adhesive can be a silicone adhesive. Solvent-cast, hot-melt, and two-part adhesives can be used. Each of the adhesive layers can independently have a thickness of 0.00025 to 0.010 inches (0.006 to 0.25 mm), or 0.0005 to 0.003 inches (0.01 to 0.08 mm).

Provided is a method of forming the disclosed compressible battery including forming the first sheet by additive manufacturing; forming the polymer structures by additive manufacturing; and forming the second sheet by additive manufacturing. Other methods of forming the compressible battery can include, for example, molding, casting, or a combination thereof, as disclosed herein.

A wide variety of additive manufacturing or three-dimensional (3D) printing methods can be used, for example fused deposition modeling (FDM), selective laser sintering (SLS), selective laser melting (SLM), electronic beam melting (EBM), Big Area Additive Manufacturing (BAAM), ARBURG plastic free forming technology, laminated object manufacturing (LOM), pumped deposition (also known as controlled paste extrusion), or other 3D printing methods. 3D printing can be used in the manufacture of prototypes or as a production process.

Material extrusion techniques are particularly useful with thermoplastics, and can be used to provide intricate features. Material extrusion techniques include techniques such as FDM, pumped deposition, and fused filament fabrication, as well as others as described in ASTM F2792-12a. In fused material extrusion techniques, an article can be produced by heating a thermoplastic material to a flowable state that can be deposited to form a layer. The layer can have a predetermined shape in the x-y axis and a predetermined thickness in the z-axis. The flowable material can be deposited as described above, or through a die to provide a specific profile. The layer cools and solidifies as it is deposited. A subsequent layer of melted thermoplastic material fuses to the previously deposited layer, and solidifies upon a drop in temperature. Extrusion of multiple subsequent layers builds the desired shape of the volume. In particular, an article can be formed from a three-dimensional digital representation of the article by depositing the flowable material on a substrate in an x-y plane to form the layer. The position of the dispenser (e.g., a nozzle) relative to the substrate is then incremented along a z-axis (perpendicular to the x-y plane), and the process is then repeated to form an article from the digital representation. The dispensed material is thus also referred to as a “modeling material” as well as a “build material.”

The volume can be extruded from two or more nozzles, each extruding the same dielectric composition. If multiple nozzles are used, the method can produce the product objects faster than methods that use a single nozzle, and can allow increased flexibility in terms of using different polymers or blends of polymers, different colors, or textures, and the like. A composition or property of a single volume can be varied during deposition using two nozzles.

Material extrusion techniques can further be used for deposition of compositions. For example, at least two streams can be mixed and deposited to form the volume. A first stream can include catalyst and a second stream can optionally comprise an activating agent. One or both of the first stream and the second stream or a third stream can comprise the monomer or curable composition (e.g., resin). One or both of the first stream and the second stream or a third stream can comprise one or both of a dielectric filler and an additive. One or both of the dielectric filler and the additive can be added to the mold prior to injecting the composition.

For example, a method of preparing the volume can comprise mixing a first stream comprising the catalyst and a first monomer or curable composition and a second stream comprising the optional activating agent and a second monomer or curable composition. The first and second monomer or curable composition can be the same or different. One or both of the first stream and the second stream can comprise the dielectric filler. The dielectric filler can be added as a third stream, for example, further comprising a third monomer. The depositing of one or more of the streams can occur under an inert gas, for example, nitrogen or argon. The mixing can occur prior to deposition, in an inline mixer, or during deposition of the layer. Full or partial curing (polymerization or crosslinking) can be initiated prior to deposition, during deposition of the layer, or after deposition. Partial curing can be initiated prior to or during deposition of the layer, and full curing is initiated after deposition of the layer or after deposition of the plurality of layers that provides the volume.

A support material can optionally be used to form a support structure. The build material and the support material can be selectively dispensed during manufacture of the article to provide the article and a support structure. The support material can be present in the form of a support structure, for example a scaffolding that can be mechanically removed or washed away when the layering process is completed to the desired degree.

Stereolithographic techniques can also be used, such as selective laser sintering (SLS), selective laser melting (SLM), electronic beam melting (EBM), and powder bed jetting of binder or solvents to form successive layers in a preset pattern. With stereolithographic techniques, layer-by-layer buildup can occur by polymerizing or crosslinking each layer.

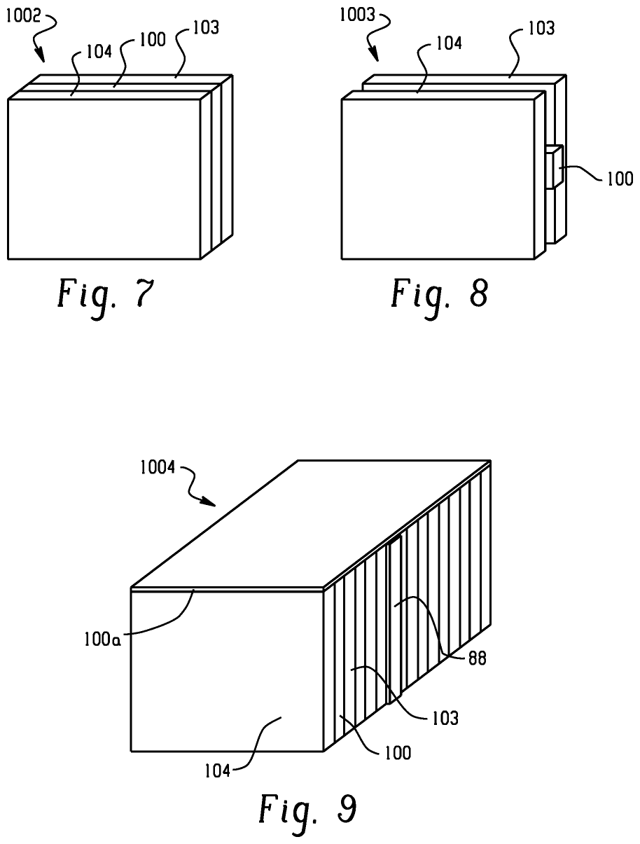

Provided is a battery including more than one cell and the disclosed compressible battery pad between adjacent cells. The compressible battery pad can be disposed on an electrochemical cell to provide a cell assembly for a battery. The cells can be lithium-ion cells, in particular, prismatic, cylindrical, or pouch cells. FIG. 7 illustrates an aspect of the positioning of the compressible battery pad in a cell assembly 1002 and FIG. 8 illustrates an aspect of the positioning of the compressible battery pad in a cell assembly 1003. FIG. 7 and FIG. 8 illustrate that the compressible battery pad 100 can be located between a first cell 103 and a second cell 104. FIG. 7 illustrates that the compressible battery pad 100 can be approximately the same size as the height and width of the cells 103, 104. FIG. 8 illustrates that the compressible battery pad 100 can be smaller than the respective cells 103, 104. Also as shown in FIG. 8 it is also possible for the compressible battery pad 100 to extend past an edge of an electrochemical cell 103, 104. A compressible battery pad extending past an edge of an electrochemical cell can wrap around and cover at least another portion or all of another surface of the cell.

FIG. 9 illustrates that multi-cell assembly 1004 can include more than two cells 103, 104 with compressible battery pad 100 located in between the respective cells 103, 104. The cells can be lithium-ion cells, in particular pouch cells. FIG. 9 illustrates that an assembly 1004 for a battery can include more than two cells (e.g., 103, 104) with compressible battery pad 100 located in between the respective cells 103, 104 and each of the other cells. Two to ten compressible battery pads can be disposed on a cell or in a cell array during manufacture of the assembly 1004 for a battery. For example, two to ten compressible battery pads can be disposed on the interior, e.g., facing the electrodes, or exterior, facing outside of the battery. Two to ten compressible battery pads can be disposed on or adhered to a cell or pouch of a pouch cell, or both. Of course, one or more than ten of the compressible battery pads can be present depending on the number of cells and cell arrays. FIG. 9 further illustrates compressible battery pad 100a disposed on an exterior of assembly 1004 for a battery, to face outside of a battery.

At least a portion of an exposed outer edge of the compressible battery pad can include a material 88 that pulls heat away from the body of the compressible battery pad. Exemplary materials to apply to an exposed edge of the compressible battery pad include ceramics such as boron nitride or aluminum nitride, a metal such as aluminum, a high heat capacity wax, a phase change material, or the like, or a combination thereof.

The cell assemblies are used in batteries. A battery includes a housing that at least partially encloses one or more electrochemical cells or cell arrays. The housing can be of any suitable type, for example, a polymer or a pouch of a pouch cell. The compressible battery pad can be disposed on, or disposed directly on a cell or cell array in any suitable configuration in the battery. The compressible battery pad can be placed between individual cells or cell arrays in the battery. The compressible battery pad can be placed on, e.g., at the top, in between, below, adjacent, or a combination thereof the sides of the cells or cell arrays in the battery, a portion thereof, or a selected set of cells or cell arrays in the battery. The compressible battery pad can be placed or adhered to a plurality of pouch cells, pressure management pads, cooling plates, or other interior battery components. The assembly pressure of the battery can hold stacked components into place.

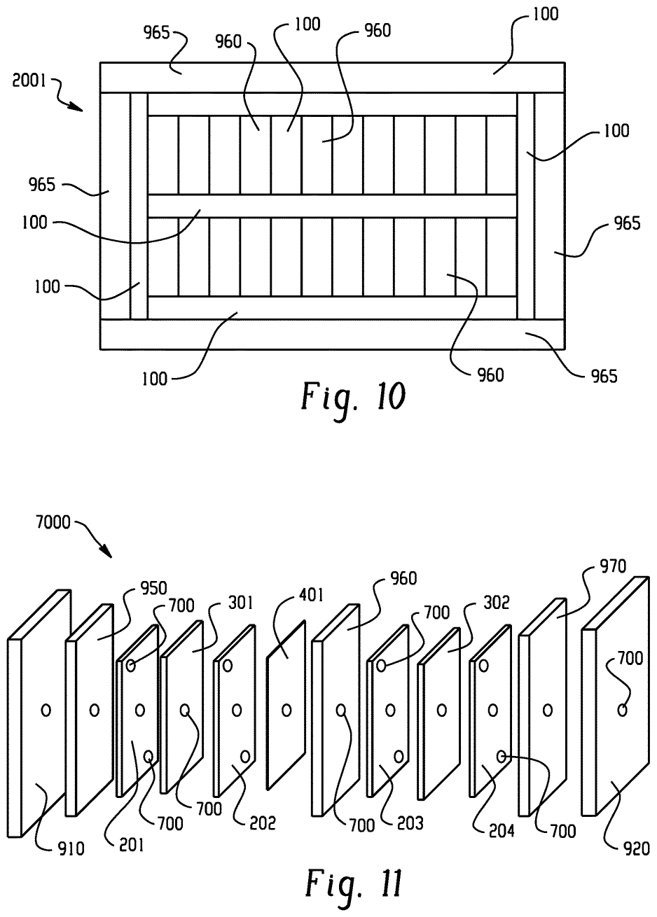

For example, as shown in FIG. 10, a battery 2001 can contain a plurality of cells in a plurality of cell arrays 960 inside a housing 965. The compressible battery pad 100 can be disposed between two cell arrays 960. Further as shown in FIG. 10, the compressible battery pad 100 can be disposed between a side of housing 965 and a side of a cell array 960, along a plurality of the cells of the cell array. Also as shown in FIG. 10, the compressible battery pad 100 can be disposed between an end of housing 965 and an end of one or more cell arrays 960.

If more than one compressible battery pad or other layer is used, the pads and layers can be assembled by suitable methods. The pads and layers can be assembled on a surface of a cell or other component of a battery (for example, a wall of a battery case). The pads and layers can be assembled separately, and then placed or adhered to the cell, the battery component, or both. Each of the pads or layers can be manufactured separately, and then stacked (placed or adhered using, for example, one or more adhesive layers) in the desired order. Alternatively, one or more individual layers can be manufactured on another individual layer, for example, by coating, casting, or laminating using heat and pressure. Direct coating or casting can decrease thickness and improve flame retardance by eliminating an adhesive layer.

The following examples are provided to illustrate the present disclosure. The examples are merely illustrative and are not intended to limit devices made in accordance with the disclosure to the materials, conditions, or process parameters set forth therein.

### EXAMPLES

Heat transfer of uncompressed and compressed battery pads made of high density polyurethane foams was modelled. The model was that of a four-cell thermal runaway test shown in FIG. 11, which is an exploded views of a schematic of an apparatus 7000 for modeling of the thermal runaway test, including aluminum end plates 910, 920 (having dimensions of 17.5 millimeters (mm)×241 mm×431 mm), 80 amp-hours (Ah) cells at full state of charge (SOC) 201, 202, 203, 204 (15 mm thick), two millimeter thick aluminum plate cooling fins 301, 302, flexible resistive heater 401 that generates heat with an applied voltage, and the battery pads 950, 960, 970 tested.

Modelling was carried out using Ansys Mechanical Transient Thermal Module. The heat generated from the flexible resistive heater 401 is used as a heat flux input to the right side of the cell 202, which is in contact with the flexible resistive heater 401, which causes an internal temperature of cell 202 to increase. Once the internal temperature of cell 202 reaches a trigger temperature of 220 degrees Celsius, cell 202 is simulated to produce a rapid gaussian heat generation rate. Heat then propagates from cell 202 to the rest of the components in the apparatus and the temperature is monitored using multiple thermocouples 700 throughout the system over time. If an internal temperature reaches the trigger temperature in each of cells 201, 203, 204, heat will similarly propagate from the cell 201, 203, 204.

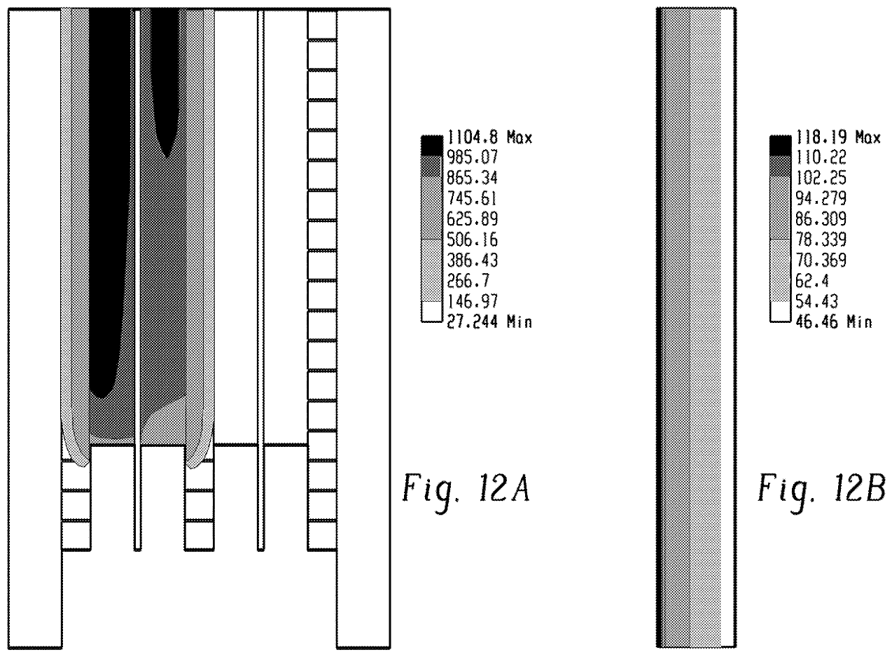

FIG. 12A and FIG. 12B show modeling of a thermal runaway test including a battery pad in accordance with a structure as shown in FIG. 1A having an uncompressed thickness of 10 millimeters (mm). The presence of air or voids within the battery pad enhances thermal resistance of the battery pad, mitigating thermal runaway and limiting the temperature of cell 203 to a maximum of 119° C.

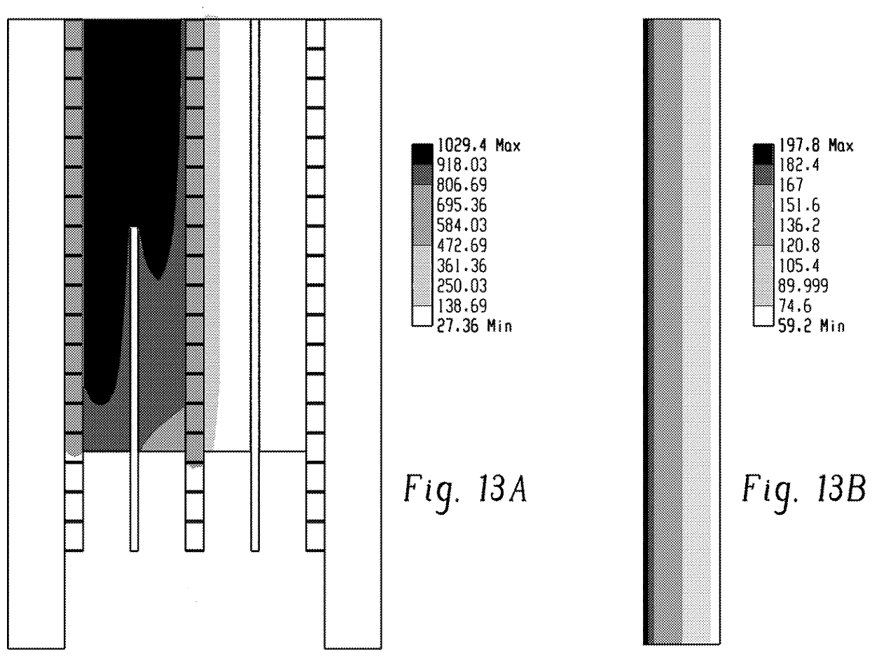

FIG. 13A and FIG. 13B show modeling of a thermal runaway test including a battery pad in accordance with a structure as shown in FIG. 1A having an uncompressed thickness of 5 mm. The presence of air or voids within the battery pad enhances thermal resistance of the battery pad, mitigating thermal runaway and limiting the temperature of cell 203 to a maximum of 200° C. The battery pad having an uncompressed thickness of 5 mm has a lower overall thermal resistance than the battery pad having an uncompressed thickness of 10 mm, per FIG. 12A and FIG. 12B. The model also approximates a battery pad having an uncompressed thickness of 10 mm compressed to 5 mm with linearly deformed structures.

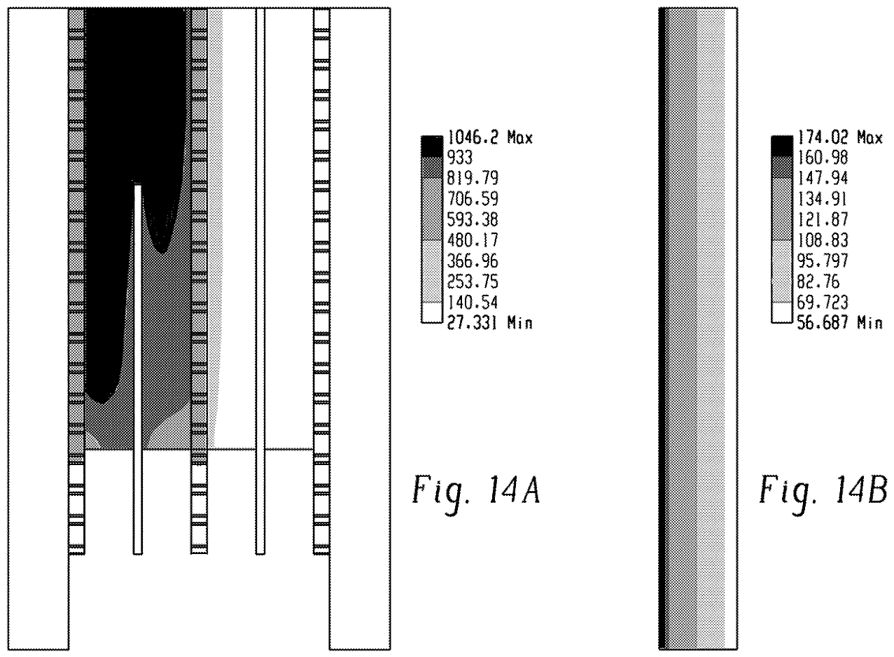

FIG. 14A and FIG. 14B show modeling of a thermal runaway test including a battery pad in accordance with a structure as shown in FIG. 1A having an uncompressed thickness of 10 mm, compressed in accordance with FIG. 1B to a thickness of 5 mm, with the polymer structures resultantly non-linearly deforming, for example, buckling, rather than linearly compressing. In addition to the presence of air or voids within the battery pad, a length of the polymer structures is retained, and a thermal resistance of the battery pad is further enhanced, mitigating thermal runaway and limiting the temperature of cell 203 to a maximum of 175° C. The battery pad has a lower overall thermal resistance than the battery pad having an uncompressed thickness of 5 mm, per FIG. 13A and FIG. 13B.

A comparison of the results of the modeling shown in FIGS. 13A and 13B with the results of the modeling shown in FIG. 14A and FIG. 14B shows that for a same pad thickness of 5 mm, a lower neighboring cell 203 temperature is achieved with a battery pad with non-linearly deformed, for example, buckled, structures as compared to a battery pad with linearly deformed structures.

Set forth below are non-limiting aspects of this disclosure.

Aspect 1: A compressible battery pad comprising a first polymer sheet; a second polymer sheet spaced apart from the first polymer sheet in a first direction; and polymer structures contacting the first polymer sheet and the second polymer sheet, extending in the first direction between the first polymer sheet and the second polymer sheet, and spaced apart from one another in a second direction orthogonal to the first direction, wherein the polymer structures are configured to non-linearly deform when a compressive force is applied to the first polymer sheet toward the second polymer sheet, the second polymer sheet toward the first polymer sheet, or a combination thereof.

Aspect 2: The compressible battery pad of aspect 1, wherein the polymer structures are not symmetric in the second direction.

Aspect 3: The compressible battery pad of aspect 1 or 2, wherein the polymer structures are not symmetric in the first direction.

Aspect 4: The compressible battery pad of any of the preceding aspects, wherein each of the polymer structures comprises a first dimension measured in the second direction at the first polymer sheet, and a second dimension measured in the second direction at the second polymer sheet, and the first dimension is not equal to the second dimension.

Aspect 5: The compressible battery pad of any of the preceding aspects, wherein each of the first polymer sheet, second polymer sheet, and polymer structures comprises silicone.

Aspect 6: The compressible battery pad of any of the preceding aspects, wherein each of the first polymer sheet, second polymer sheet, and polymer structures comprises polyurethane.

Aspect 7: The compressible battery pad of any of the preceding aspects, wherein each of the first polymer sheet, second polymer sheet, and polymer structures comprises a nonporous structure.

Aspect 8: The compressible battery pad of any of the preceding aspects, wherein each of the first polymer sheet, second polymer sheet, and polymer structures comprises a foam.

Aspect 9: The compressible battery pad of any of aspect 8, wherein the foam comprises open cells.

Aspect 10: The compressible battery pad of any of aspect 8, wherein the foam comprises closed cells.

Aspect 11: The compressible battery pad of any of aspect 8, wherein the foam comprises open cells and closed cells.

Aspect 12: The compressible battery pad of any of the preceding aspects, wherein each of the polymer structures is bonded to the first polymer sheet, the second polymer sheet, or a combination thereof.

Aspect 13: The compressible battery pad of any of the preceding aspects, wherein the compressible battery pad comprises a monolith.

Aspect 14: A battery comprising more than one cell; and the compressible battery pad of any of the preceding aspects between adjacent cells.

Aspect 15: A method of forming the compressible battery pad of any of the preceding aspects comprising forming the first sheet by additive manufacturing; forming the polymer structures by additive manufacturing; and forming the second sheet by additive manufacturing.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

The terms “a” and “an” do not denote a limitation of quantity, but rather denote the presence of at least one of the referenced items. Reference to “an” element in a claim followed by reference to “the” element is inclusive of one element and a plurality of the elements. The term “or” means “and/or” unless clearly indicated otherwise by context. Reference throughout the specification to “an aspect,” “another aspect,” and so forth, means that a particular element (e.g., feature, structure, step, or characteristic) described in connection with the aspect is included in at least an aspect described herein, and may or may not be present in other aspects. In addition, it is to be understood that the described elements can be combined in any suitable manner in the various aspects.

When an element such as a layer, film, region, or substrate is referred to as being “on” another element, it can be directly on the other element or intervening elements can also be present. In contrast, when an element is referred to as being “directly on” another element, there are no intervening elements present.

Properties of elements illustrated in the Figures may be described herein with terms related to orientation, such as “height” and “width.” It will be understood that such terms related to orientation are intended to encompass different orientations of the device in addition to the orientation depicted in the Figures. For example, if the device in one of the figures is turned, elements described with reference to term the “height” could then be described with reference to term “width.” The exemplary term “height,” can therefore, encompass a “height” or “width,” depending on the particular orientation of the figure.

Unless specified to the contrary herein, all test standards are the most recent standard in effect as of the filing date of this application, or, if priority is claimed, the filing date of the earliest priority application in which the test standard appears.

The endpoints of all ranges directed to the same component or property are inclusive of the endpoints, are independently combinable, and include all intermediate points and ranges. For example, ranges of “up to 25 wt %, or 5 to 20 wt %” is inclusive of the endpoints and all intermediate values of the ranges of “5 to 25 wt %,” such as 10 to 23 wt %, etc.). The terms “first,” “second,” and the like, “primary,” “secondary,” and the like, as used herein do not denote any order, quantity, or importance, but rather are used to distinguish one element from another. The term “combination thereof” is open, and means that the list is inclusive of each element individually, as well as combinations of two or more elements of the list, and combinations of at least one element of the list with like elements not named. Also, the term “combination” is inclusive of blends, mixtures, alloys, reaction products, and the like.

Unless defined otherwise, technical and scientific terms used herein have the same meaning as is commonly understood by one of skill in the art to which this disclosure belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

In the drawings, the widths and thicknesses of layers and regions can be exaggerated for clarity of the specification and convenience of explanation. Like reference numerals in the drawings denote like elements.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat can, typically, have rough and/or nonlinear features. Moreover, sharp angles that are illustrated can be rounded. Thus, the regions illustrated in the figures are schematic in nature and their shapes are not intended to illustrate the precise shape of a region and are not intended to limit the scope of the present claims.

While particular aspects have been described, alternatives, modifications, variations, improvements, and substantial equivalents that are or can be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A compressible battery pad comprising:
a first polymer sheet;
a second polymer sheet spaced apart from the first polymer sheet in a first direction; and
polymer structures
contacting the first polymer sheet and the second polymer sheet,
extending in the first direction between the first polymer sheet and the second polymer sheet, and
spaced apart from one another in a second direction orthogonal to the first direction,
wherein the polymer structures are configured to non-linearly deform when a compressive force is applied to
the first polymer sheet toward the second polymer sheet,
the second polymer sheet toward the first polymer sheet, or
a combination thereof.

2. The compressible battery pad of claim 1, wherein the polymer structures are not symmetric in the second direction.

3. The compressible battery pad of claim 1, wherein the polymer structures are not symmetric in the first direction.

4. The compressible battery pad of claim 1, wherein:
each of the polymer structures comprises
a first dimension measured in the second direction at the first polymer sheet, and
a second dimension measured in the second direction at the second polymer sheet, and
the first dimension is not equal to the second dimension.

5. The compressible battery pad of claim 1, wherein each of the first polymer sheet, second polymer sheet, and polymer structures comprises silicone.

6. The compressible battery pad of claim 1, wherein each of the first polymer sheet, second polymer sheet, and polymer structures comprises polyurethane.

7. The compressible battery pad of claim 1, wherein each of the first polymer sheet, second polymer sheet, and polymer structures comprises a nonporous structure.

8. The compressible battery pad of claim 1, wherein each of the first polymer sheet, second polymer sheet, and polymer structures comprises a foam.

9. The compressible battery pad of claim 8, wherein the foam comprises open cells.

10. The compressible battery pad of claim 8, wherein the foam comprises closed cells.

11. The compressible battery pad of claim 8, wherein the foam comprises open cells and closed cells.

12. The compressible battery pad of claim 1, wherein each of the polymer structures is bonded to the first polymer sheet, the second polymer sheet, or a combination thereof.

13. The compressible battery pad of claim 1, wherein the compressible battery pad comprises a monolith.

14. A battery comprising:
more than one cell; and
the compressible battery pad of claim 1 between adjacent cells.

15. A method of forming the compressible battery pad of claim 1 comprising:
forming the first sheet by additive manufacturing;
forming the polymer structures by additive manufacturing; and
forming the second sheet by additive manufacturing.
